(19) United States
(12) Patent Application Publication
(10) Pub. No.: US 2012/0171596 A1
(43) Pub. Date: Jul. 5, 2012

(54) SOLID OXIDE ELECTROLYTIC DEVICE

(76) Inventor: Donald Bennett Hilliard, El Granada, CA (US)

(21) Appl. No.: 13/261,202

(22) PCT Filed: Aug. 4, 2010
(86) PCT No.: PCT/US10/02178

§ 371 Date: Mar. 4, 2012

Related U.S. Application Data
(63) Continuation-in-part of application No. 12/803,213, filed on Jun. 21, 2010.
(60) Provisional application No. 61/273,428, filed on Aug. 4, 2009.

(51) Int. Cl. H01M 8/10; C23F 1/02; C25B 9/08

(52) U.S. Cl. 429/482; 204/252; 204/260; 216/39

(57) ABSTRACT

A monolithic electrolyte assembly comprising improved as well as new associated structures and processes operative in the general field of solid oxide electrolytic devices is disclosed. The invention provides a reliable and durable interconnect for both structural and electrical components of such devices. In the present invention, thin-film-based solid oxide fuel cells and solid oxide oxygen/hydrogen generators may be fabricated using primarily solid metal alloys as underlying components of thin film and thick film structures built thereon.

### TECHNICAL FIELD

The present invention is related to and claims the benefit of U.S. provisional patent application 61/273,428 (Hilliard), filed Aug. 4, 2009, and U.S. non-provisional patent application Ser. No. 12/803,213 (Hilliard), filed Jun. 21, 2010, both of which applications are, in their entirety, incorporated herein by reference. The present invention relates in general to solid-oxide electrolyte-based devices, including solid oxide fuel cells (SOFC's), oxygen generation systems (OGS), solid-oxide-based gas separation systems, gasification systems, and novel interconnect structures in such devices. In particular, the invention relates to the use metal-supported structures in these devices, and the use of thin-film and photochemical machining methods for providing monolithic electrolytic assemblies of such devices.

### BACKGROUND ART

Electrolytic devices based on solid oxide electrolytes, such as yttria-stabilized zirconia (YSZ), cerium gadolium oxide (CGO), or lanthanum gallate (LGO), have become increasingly important for a variety of applications involving electricity generation and gas separation devices. Essentially, what may be referred to variously as monolithic positive-electrode/electrolyte/negative-electrode (PEN) assemblies, monolithic electrolytic assemblies, or membrane-electrode assemblies, utilized in the high-temperature, ceramic-based, solid-oxide fuel cell and gas separation membranes, have been proposed and fabricated utilizing various microelectronic and other micro-fabrication methods for providing a PEN structure that is based on a grid that is formed in a thin substrate sheet, such as a silicon wafer, a glass substrate, ceramic substrate, or thin high-temperature alloy sheet. Much of the earlier work in this area of development was performed by utilizing silicon MEMS fabrication processes, for example, at LLNL, U.S. Pat. No. 6,007,683 (Jankowski), where grids were formed in silicon wafers by means of sputtering and reactive ion etching (RIE). However these methods are expensive in capital and materials costs. Later, efforts were launched for forming SOFC devices on less expensive materials, notably by screen printing, isostatic pressing, and electrophoretic deposition (U.S. Pat. No. 6,794,075, US pat appln 20040115503). However, these generally utilize thick film methods wherein the electrolyte tends to be thicker than 10 um. Others, including the present author have pursued SOFC-type cell structures by means of thin film methods that are amenable to sub-micron electrolyte layers (U.S. patent application Ser. No. 10/411,938). More specifically, past work has produced PEN structures utilizing inexpensive alloys such as ferritic, martensitic, and austenitic steel strip, wherein an array of free-standing solid oxide electrolyte layers are formed with an undulating, wave-like, or corrugated surface that provides high thermo-mechanical shock resistance, as well as increases surface area for high power density operation of the cell. However, available surface area is limited by the limitations of the available open surface area of the metal grid. By methods such as photochemical machining or electroforming, available open surface area can not be realized by conventional methods that is appreciably greater than 60%; and, as hole pitch of the supporting grid is decreased below 250 um, the available open area in a plan view will decrease substantially below 60%. At the same time, resultant structures formed by these methods result in limitation of gas diffusion properties that are critical to cell operation.

### DISCLOSURE OF INVENTION

In accordance with the preferred embodiments, the present invention provides a structure for use in such solid oxide electrolytic devices as solid oxide fuel cells (SOFC's) and solid-state oxygen generator systems (OGS'). The present invention teaches improved monolithic electrolytic assemblies (MEA, or, equivalently membrane-electrode assembly), structures, and methods for constructing substantially planar SOFC structures derived preferably from thin film methods and photochemical machining (PCM) technologies.

In its preferred embodiments, the present invention is a MEA support structure wherein a periodic array of individual through-hole structures formed in foil-type metallic support structures of the prior art are improved so as to provide additional structural features, the additional structural features comprising a segmentation of contact surfaces of the embodied MEA, preferably so that via features are additionally provided in the support structure and resultant MEA. Such via features are preferably disposed so as to provide a means for gas-phase communication between individual through-hole structures of the support structure, so that there is enabled an according enhancement of gas flow over the MEA layers subsequently formed over such via features of the support structure.

In the first preferred embodiments, each through-hole structure, and each corresponding “unit cell” of the resultant MEA, comprises six separate regions of contact surface at its periphery positioned symmetrically about the inner surfaces of the through-hole structure, the regions of contact surfaces separated by six via features, wherein the six via features provide gaseous communication between surfaces of the resultant unit cell and six adjacent unit cells that are accordingly its nearest-neighbors in the preferred hexagonal arrangement. Such arrangement of contact surfaces and via features is preferably disposed at both cathodic-acting and anodic-acting sides of the MEA, so that a given unit cell of the embodied MEA is preferably provided with a total of twelve such separate regions of contact surface; six separate regions of contact surface on cathode side and six separate regions of contact surface on anode side. Accordingly, each unit cell of the embodied MEA is also preferably provided with twelve via structures, with six separating each of the separate regions of contact surface disposed on either side if the MEA.

The preferred segmentation of contact surfaces is additionally advantageous for purposes of attaining uniform contact between interfacing surfaces, so that the mating interconnect surfaces, whether of adjacent bipolar interconnect plates or adjacent auxiliary gas reformer elements, may be formed to provide a complementary arrangement of contact surfaces that additionally provide gas-flow channels for providing gas flow within solid-oxide electrolytic devices that incorporate the embodied MEA structure. A further advantage of the present invention is the embodied methods for fabrication of thin-film MEA's that incorporate a large surface of actively participating solid-oxide thin film electrolyte, such surface percentage measured as a percentage of the planar area of the MEA support structure that is dedicated to electrolytic activity.

In the preferred embodiments, the actual surface area of the thin film electrolyte that is directly utilized as an oxygen ion conductor, or equivalently, that portion of the film that is exposed on opposite sides to gas-transporting media, is greater than 70%, and preferably greater than the projected area of the corresponding active region of the MEA. Further advantages are provided in the embodied PCM methods, wherein, in conjunction with the embodied MEA structures and methods, open area of a preferably hexagonal grid in such applications can be significantly increased.

Such advantages in increased active surface area in the inventive solid-oxide MEA is achieved, in part, through the embodied utilization of inventive photo-chemical machining (PCM) methods that provide grid structures wherein open area of the grid supporting active electrolytic layers is substantially increased. In conjunction with the embodied MEA fabrication processes and PCM methods, hole diameters are increased, and cross-member widths are decreased, thereby providing an over-all increase in open area in an active area of the MEA support structure; furthermore, the surface area provided by the solid oxide electrolytic layer is significantly greater than that achievable by prior art methods such as forming solid-oxide electrolyte layers in the micropores of metal fits, porous ceramics, or other such random arrays of holes afforded by the formation of porous substrates materials. Further advantage of the present invention accordingly comprises the described inventive processes and methods by which the inventive MEA structures are fabricated.

In a further embodiment, the embodied via features may be utilized in conjunction with an adjacent, mechanically decoupled, porous electrode; and, additionally, a planar bipolar interconnect, so as to form a circuit of gas channels within a preferred electrolytic device, or else such via features may be utilized in conjunction with gas flow features of interconnect surfaces, so that desired conductance of an operating gas is realized.

The embodied approach using a hexagonal array of contact regions and associated contact surfaces is further found useful in the integration of porous electrode layers for various catalytic and gas shift processes commonly associated with anode and cathode of MEA's in gas separation and fuel cell operations.

Further advantages of the present invention are embodied in specific electrolytic stack designs that are uniquely enabled by the embodied MEA. The MEA of the preferred embodiments may be incorporated in a variety of electrolytic devices, namely comprising SOFC and OGS systems. In particular, the MEA's of the preferred embodiments may be advantageously utilized in substantially planar configurations, wherein, in addition to the conventional employment of bipolar interconnect plates, which are preferably on the same order of thickness as the MEA's, additional monolithic stainless steel -supported porous electrode layers are disposed in between bipolar interconnect plates and MEA's of the previous embodiments, wherein such additional decoupled monolithic porous electrode assemblies (DMPEA's) are fabricated having arrays of contact surfaces roughly identical in placement to that of the inventive MEA's.

In another embodiment of the invention, bipolar interconnect plates, MEA's, and decoupled electrode assemblies, are preferably formed as thin annular disks, wherein MEA's and decoupled electrode assemblies preferably incorporate active regions as annular regions intermediate to concentric inner and outer sealing regions. Such annular elements are stacked concentrically to form accordingly annular electrolytic cell stacks that effectively comprise a tubular stack of planar elements, preferably comprising a solid oxide fuel cell for generation of electricity, or alternatively, an OGS for gas separation and generation. The disclosed annular electrolytic stack preferably provides radial flow means for flow of operating gases flowing over both electrode and counter-electrode sides of the embodied planar electrolytic cell. Furthermore, it is preferred that the annular stack provide heat exchange means within the central volume accordingly formed by the annular geometry, as well as heat exchange means uniformly disposed about the annular stack perimeter.

In a further aspect, the disclosed annular stack incorporates gas-flow manifolds and channels that effectively mirror gas flow patterns about the central plane of the stack, wherein end caps disposed at opposite ends of the stack are each disposed to provide both supply and return means for operating gases of both electrodes and counter-electrodes of a mirrored-stack sub-assembly, so that the stack comprises two sub-stacks mirrored about the central plane of the stack. Such mirrored gas flow geometry is advantageous in achieving symmetrical thermal control of the stack, as well as improved control of thermal gradients, when utilized in conjunction with the preferred embodiments.

Accordingly, it is an object of the present invention to provide a MEA structure which is suitable for the high temperature environment of solid oxide fuel cells and gas separation devices.

Another objective of the present invention is to provide a means for using roll-milled stainless steel alloys to comprise all bulk components of a solid oxide electrolytic device.

Yet another object of the present invention is to provide a monolithic solid oxide-based monolithic electrolytic assembly using a pixilated array of bubble-shaped thin-film electrolytes.

Another object of the present invention is to provide an oxygen generator that utilizes only bulk, machineable metal alloys as support structures.

Another object of the present invention is to provide a thin film solid oxide fuel cell structure which does not utilize porous bulk ceramics or porous metal frits as a support structure.

Another object of the present invention is to provide a method for forming solid oxide electrolytic assemblies by roll-to-roll processing.

Another object of the present invention is to provide mechanically flexible solid oxide electrolytic assemblies.

Another object of the present invention is to provide a thin film solid oxide electrolytic device that provides flexibility through use of non-planar thin film electrolytes.

Another object of the present invention is to provide an MEA comprising a hexagonal array of suspended electrolytic membranes on a thin steel support structure of sheet aspect wherein the electrolytically active membrane area is greater than 70 percent of, and more preferably, greater than, the area of the original sheet dedicated to the active membrane region.

Another object of the present invention is to provide an MEA comprising a hexagonal array of suspended electrolytic membranes on a thin steel support structure of sheet aspect wherein the average area of the open space disposed for providing active membrane, as defined by planar area of the array, is greater than 40 percent of, and more preferably, greater than 60 percent of the area of the planar area.

Another object of the present invention is to provide an MEA comprising a hexagonal array of suspended electrolytic membranes on a thin steel support structure of sheet aspect wherein a photochemical machining process provides a perforated sheet with greater than 50% open area.

Another object of the present invention is to provide a support structure comprising a monolithic electrolytic membrane (MEA), wherein a repeated section of the support structure provides recessed regions comprising via for transport of operating gases therein.

Another object of the present invention is to provide a support structure comprising a monolithic electrolytic membrane (MEA), wherein a repeated section of the support structure provides a corrugated electrolytic thin film that is contained substantially within upper and lower planes defining upper and lower surface of the support structure

Another object of the present invention is to provide a support structure comprising a monolithic electrolytic membrane (MEA), wherein a repeated section of the support structure provides support structure for electrolytic membranes, wherein an electrolytic thin film membrane is formed with the periodic structure of an egg-carton.

Another object of the present invention is to provide a thin metal support structure with a predetermined periodic array of contact surfaces that extend above and below the confines of an integral electrolytic film.

Another object of the present invention is to provide a thin metal support structure with a predetermined periodic array of contact surfaces that are arranged with circular symmetry around about a predetermined array of supported electrolytic membrane regions.

Another object of the present invention is to provide a chemically machined thin metal support structure 50 microns to 500 microns thick with a predetermined periodic array of contact surfaces separated by via structures, the periodic array of contact surfaces and via structures interspersed between a predetermined array of electrolytic unit cells, the unit cells each defined by a through-hole structure spanned a suspended electrolytic membrane.

Yet another object of the invention is to provide a planar SOFC, or alternatively a planar OGS, which comprises a planar SOFC in the shape of a tube.

Another object of the invention is to provide a planar SOFC stack that is annular, and is mirrored, in its functions and features, about a middle plane of the planar stack

Other objects, advantages and novel features of the invention will become apparent from the following description thereof.

### BRIEF DESCRIPTION OF DRAWINGS

FIG. 1 (prior art) is a sectional side view of a portion of the active region in a solid-oxide monolithic electrode/electrolyte assembly (MEA).

FIG. 2 is an exploded perspective view of the first side (16) of a support structure used in MEA's of the preferred embodiments.

FIG. 3 is an exploded perspective view of the second side (18) of a support structure used in MEA's of the preferred embodiments.

FIG. 4 is a standard triple view of the invention, with captioned top plan-view ‘A’ of the second side of a support structure of the preferred embodiments, and corresponding sectional side view ‘B’ along axis X in view ‘A’, and sectional side view ‘C’ along axis Y in view ‘A’.

FIG. 5(a-e) is cross-sectional views of an MEA constructed in accordance with the preferred embodiments, taken along axis X in FIG. 4, comprising a process sequence for fabrication of an MEA of preferred embodiments.

FIG. 6 is an MEA of the present invention, comprising (a) sectional side-view, and (b) exploded perspective view of second side of an MEA of the preferred embodiments.

FIG. 7(a-c) are detailed sectional side-views of support structures for MEA's in the present invention.

FIG. 8(a-e) is cross-sectional views of a support structure of the preferred embodiments, as taken along axis Y in FIG. 4, comprising preferred embodiments for fabrication of an MEA of preferred embodiments,

FIG. 9(a-d) is cross-sectional views of a support structure of the preferred embodiments, as taken along axis Y in FIG. 4, comprising an alternative process sequence for fabrication of an MEA of preferred embodiments.

FIG. 10(a-d) is cross-sectional views of a support structure of the preferred embodiments, as taken along axis X in FIG. 4, comprising an alternative process sequence for fabrication of the support structure and MEA of the preferred embodiments.

FIG. 11 is an electrolytic cell incorporating an MEA of the preferred embodiments in conjunction with mechanically decoupled reformer layers.

FIG. 12(a-c) an annular MEA in a preferred embodiment of the inventions, incorporating associated sealing and manifold features.

FIG. 13(a-c) is an annular embodiment of the embodied monolithic decoupled porous electrode assembly in accordance with a preferred embodiment.

FIG. 14(a-b) is an annular embodiment of the bipolar interconnect plate (BIP) in accordance with a preferred embodiment.

FIG. 15(a-b) is an assembly of three annular electrolytic cells in accordance with a preferred embodiment of the disclosed fuel cell stack, wherein the hollow center of the stack is broken out for clarity.

FIG. 16(a-b) is an annular fuel cell stack, or alternatively, an annular OGS, in accordance with the preferred embodiments.

FIG. 17(a-b) is, (a) a sectional side-view of an annular end-cap assembly of the preferred embodiments, and (b) a sectional side-view of an annular Unipolar Interconnect Plate (UIP) of the preferred embodiments.

FIG. 18 is a side-sectional view of a solar-powered conversion device.

FIG. 19 is a side-sectional view of a solid oxide gas separation system.

### BEST MODE FOR CARRYING OUT THE INVENTION

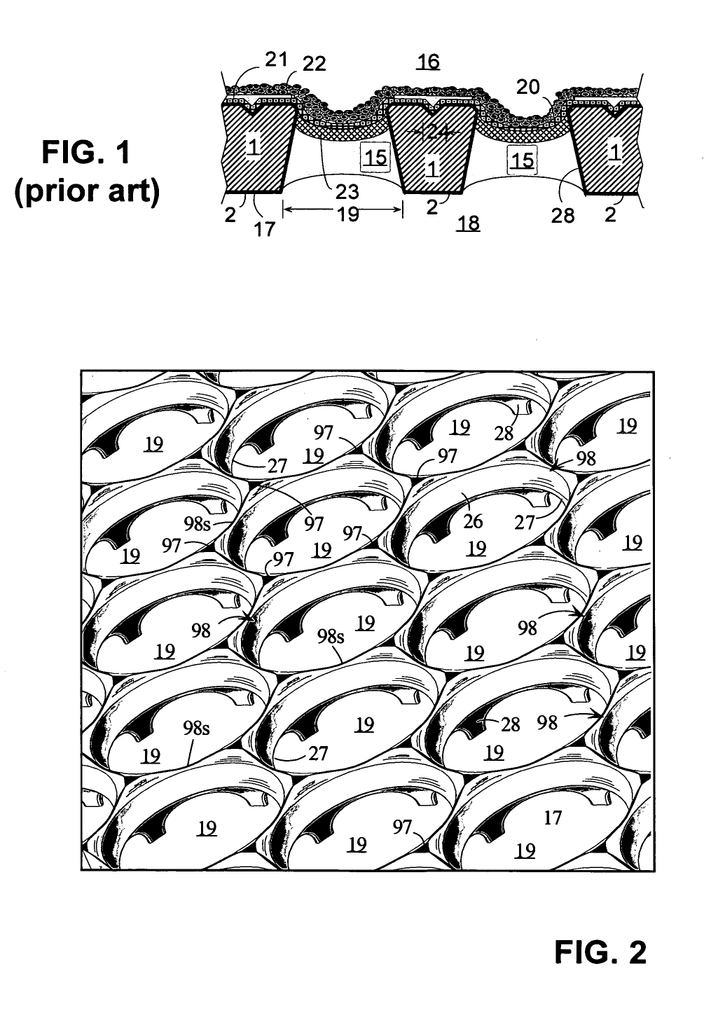

The following description and FIGS. 1-18 of the drawings depict various embodiments of the present invention. The embodiments set forth herein are provided to convey the scope of the invention to those skilled in the art. While the invention will be described in conjunction with the preferred embodiments, various alternative embodiments to the structures and methods illustrated herein may be employed without departing from the principles of the invention described herein. Like numerals are used for like and corresponding parts in the various drawings. Throughout this application various publications are referenced. The disclosures of each of these publications in their entireties are hereby incorporated by reference in this application.

A thin-film based, solid oxide, monolithic electrolytic assembly (MEA) of the prior art, in FIG. 1, in U.S. patent application Ser. No. 11/980,242 by same author, comprises a stainless steel sheet that is etched to provided a predetermined pattern of through-hole structures, wherein the through-hole structures each provide a support means for a free-standing film structure comprising a solid oxide electrolyte, anode layer, and cathode layer. The free-standing portion of the film structure, i.e. that portion not attached to the walls of the through-hole structure, is substantially non-planar for providing mechanical resilience and increased surface area.

An undulating aspect in resultant electrolytic layers of the prior art, in FIG. 1, is provided by filling of the sacrificial material (15), wherein the wetting characteristics of the particular sacrificial material chosen, as well as any surface treatment of the support structure (17), will determine the contact angle of the sacrificial material to the through-hole structure (19) of the support structure. Accordingly, the resultant solidified sacrificial material (15) may form a recess in the through-hole, as in FIG. 1, so that the thin film electrolyte (20) will possess a resulting concave shape. The electrode/electrolyte structure of FIG. 1 also contains the optional first porous electrode material (22) and second porous electrode material (23) for increasing three-phase boundary interfaces or performing various reforming functions.

Such a non-planar shape, in FIG. 1, provides for additional resistance to stress-induced cracking of the electrolyte, in the case that the support structure possesses a different C.T.E. than that of the electrolyte. Furthermore, the non-planar shape of the electrolyte in FIG. 1 provides for increased surface area, and hence, increased throughput. It should be noted that the thickness of the solid oxide electrolyte (20), in FIG. 1, is normally made quite thin relative the thickness of the electrode support structure. In the preferred embodiments, the solid oxide electrolyte is a film of a thickness corresponding to the thin film range (less than 10 um, or <1×10⁻⁵ meters), whereas the electrode support structure will typically possess a thickness in the range of hundreds of micrometers.

The finish of the metallic support structure may comprise various surface treatments, including various additional etching, pickling, polishing, electro-polishing, electroless polishing, and coating processes. It is preferable that the structure be electro-polished for smoothing purposes, and subsequently over-coated with the diffusion-barrier coatings.

In preferred embodiments of the present invention, improvements to thin-film-based, solid-oxide, MEA's comprise additional surface features formed in the support structure that enhance gas distribution between individual “unit cells” formed within each through-hole structure after an MEA is formed onto the inventive support structure. The alloy metal sheet (1), support structure (17), and resulting MEA (30) have, for purposes of clearly pointing out the invention, a first side (16) and a second side (18) comprising opposite sides of the embodied planar elements, wherein features and processes of the invention are described in conjunction with these two opposing sides. Planes defining outer planar surfaces of the planar support structure are, accordingly, the plane of the first side (16p) and the plane of the second side (18p). The electrolytic layer structures of the present invention are accordingly disposed in the electrolytically active regions of an MEA, such MEA's typically bordered by integral sealing surfaces, such as is uniformly practiced in prior art MEA's, and, namely, MEA's for which the present invention provides improvement.

In the present embodiment, the support structure (17), in FIG. 2-4, are accordingly formed preferably of a metal alloy sheet, preferably in thicknesses in the range of 0.002 to 0.020 inches. In accordance with the preferred embodiments, in FIGS. 2-4, widened, tapered, or flared, openings of the through-hole structure intersecting first and second sides of the planar support structure form inner surfaces of the embodied through-hole structure (19), wherein an intersection region exists between these two inner flared surfaces, so that there results a roughly hour-glass-shaped cross-section, insofar that there is defined a relatively constricted aperture at a position intermediate between the first and second flared surfaces of the support structure. Such surface of intersection is accordingly referred to herein as the constriction surface (27), which resides between the two inner flared surfaces of the through-hole structure, such inner flared surfaces comprising a first flared surface (26) opening to the first side and a second flared surface (28) opening to the second side, and wherein this constriction surface of the through-hole structure substantially defines the outer boundary of the subsequently formed free-standing electrolytic layer (20a) in subsequent MEA embodiments. A plane of constricting surfaces (27p) comprises an intermediate plane between, and parallel to, plane of the first side (16p) and plane of the second side (18p), such plane of constricting surfaces residing at an intermediate position corresponding to that of, on average, the limiting aperture, with aperture diameter, dₒ, of the embodied through-hole structures. Accordingly, features of the embodied support structure are considered herein to be features of the first side (16) if such features exist on the first side of the support structure with respect to the intermediate plane of constricting surfaces (27p). Similarly, features of the embodied support structure are considered herein to be features of the second side (18) if such features exist on the second side of the support structure with respect to the intermediate plane of constricting surfaces (27p).

The flared through-hole surfaces accordingly define two distinct volumes comprising a second through-hole volume (29) defined by the second flared surface (28), between the plane of the second side (18p) and the plane of constricting surfaces (27p); and, a first through-hole volume (46) defined by the first flared surface (26), between the plane of the first side (16p) and the plane of constricting surfaces (27p).

In accordance with the first preferred embodiments, the constriction surface (27) comprises a very thin annular region comprising roughly that constricted surface area formed at the intersection of the second flared surface (28) and first flared surface (26). Accordingly, such preferred constriction surface (27) may comprise a sharp or rounded edge, but generally comprises an annular surface region of the through-hole structure residing within 10 micrometers of the plane of constriction (27p).

In the present preferred embodiments, surface features are formed preferably at the intersection between adjacent through-hole structures (19) comprising a substantial segmentation of the electrical contact surface that exists immediately adjacent to each hole structure (19), so that a plurality of separate regions of contact surface (97) are formed at the periphery of each hole structure, the regions of contact surface comprising, in the preferred case of hexagonal arrays, preferably triangular-shaped surfaces that ultimately provide contact to adjacent interconnect structures of the electrolytic device.

In the first preferred embodiments, wherein the support structure comprises a hexagonal through-hole pattern, there are accordingly six separate contact surfaces arranged at the periphery of the hole structure and, accordingly, separating these six contact surface are six recessed valleys, or via features having via surfaces (98s), which via surfaces provide vias (98) that interconnect a respective through-hole volume to its nearest-neighbor through-hole volume, in FIGS. 2-4.

Such via features preferably enhance gaseous communication between adjacent unit cells (119) defined at the respective through-hole structures of the subsequently embodied MEA. Accordingly, the preferred plurality of via features is additionally advantageous as a mechanical decoupling feature for preventing stress gradients within the thin-film MEA from accruing over distances substantially greater than those accrued over a single hole structure, or unit cell (119) of the MEA, as is previously disclosed in U.S. patent application Ser. No. 11/980,242 by same author.

The second through-hole volume preferably comprises a space between the first surface and the second surface of the planar support structure for containing the convex aspect of the free-standing electrolytic film in subsequently embodied MEA's, and is therefore preferably the greater of the described first and second through-hole volumes. Accordingly, in the first preferred embodiments, the openings on the first side are preferably more constricted in their perimeter than on the second side, so that via features formed on the second side (18) of the support structure are preferably deeper as a result of their formation by an accordingly larger extent of intersection by the surfaces of the through-hole structures on the second side. In other words, the first flared surfaces (26) of individual through-hole structures (19) at the first side (16), in FIG. 2, are measured as less widened than the second flared surfaces (28) of individual through-hole structures at the second side (18), such measure preferably being the depth of the via features (98) that result by intersection of the defining through-hole surfaces.

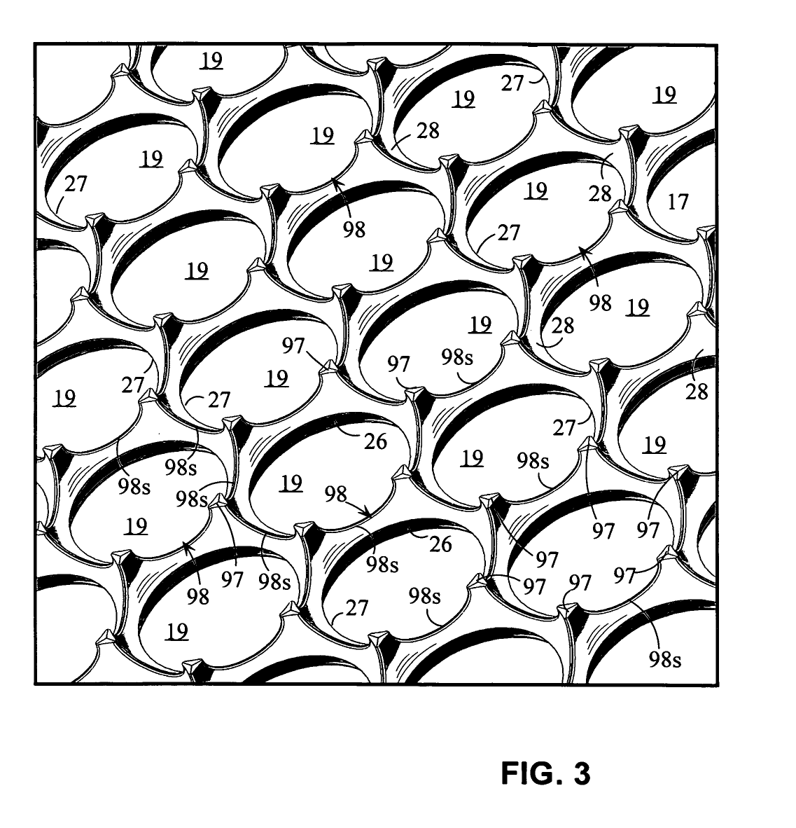

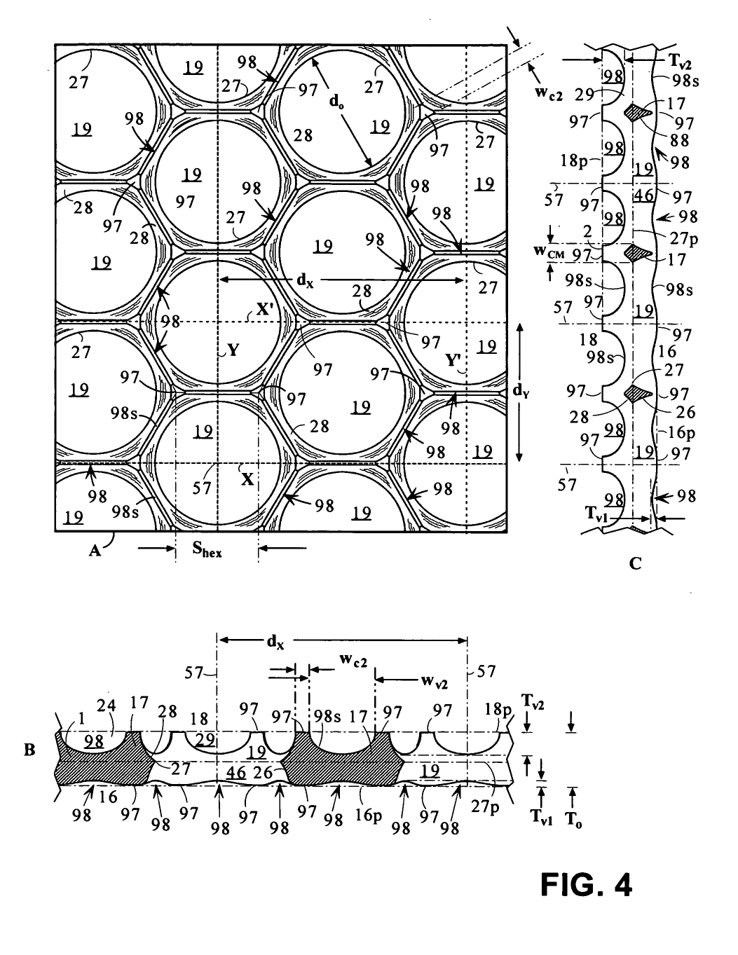

The second side (18) of a support structure of the present invention, in FIG. 3 and in captioned top-view ‘A’ in FIG. 4, comprises the side of the support structure having embodied second flared surfaces (28), and providing an accordingly larger through-hole volume (29) defined by this second flared surface (28) for containing the non-planar and free-standing region of the electrolytic film (20), is similarly formed with separate regions of contact surface (97) and via features (98) roughly corresponding to the hexagonal placement of the first side (16). It is preferable that via features formed on the second side comprise via surfaces (98s) that deviate substantially greater distances, Tᵥ₂, from the plane of the support structure's second side (18p) than corresponding via structures formed on the first side, which have smaller deviations, Tᵥ₁, from the plane of the support structure's first side (16p).

Axes, X, X′, Y, and Y′, in the lateral directions of the preferred planar support structure, in view ‘A’ of FIG. 4 correspond to major axes of the described hexagonal array, wherein, in the conventional manner of a 2-dimensinal hexagonal pattern, such axes may be rotated 120° in the plane of the structure to intersect a roughly identical structure in accordance with the three-fold symmetry of an ideal hexagonal array. The major axes pass over the centers of the through-hole structures (19) so as to roughly intersect the central axis of symmetry (57) of each through-hole structure, with such axes of symmetry accordingly defining the axis of greatest circular symmetry that the respective through-hole structure provides.

Furthermore, it is preferred that the hole pattern be hexagonal, providing close-packing characteristics commensurate with hexagonal arrangements, though a variety of roughly periodic arrays other than the preferred hexagonal array may be readily implemented, including 2D periodic arrays projected from cubic, rhombohedral, or any other such space group. While any predetermined array of through-hole structures is generally feasible, such roughly hexagonal arrangements are preferred for maximizing active area of the resultant MEA, though the present invention not intended to be limited to hexagonal arrays.

Additionally, dimensions of the support structure (17) comprise dₓ, d_{y}, and d₀, in FIG. 4, wherein: dₓ is the pitch of the hexagonal array measured along an axis X, wherein dₓ is distance measured between intersected adjacent axes of central symmetry (57) corresponding to adjacent through-hole structures centered on X; d_{y} is the pitch of hexagonal array measured along an axis Y wherein d_{y} is distance measured between intersected adjacent axes of central symmetry corresponding to adjacent through-hole structures; and, d₀ is the smallest constricting dimension, d₀, preferably the diameter of preferred circular through-hole structure at its constricting surface, 27, the constricting diameter preferably measured in the intermediate plane of constricting surface 27p.

Via surfaces (98s) separating the preferred triangular regions of contact surface (97) are formed at the intersection of adjacent second flared surfaces (28) defining the openings of adjacent through-hole structures on the second side. The intersection of these through-hole structures in the preferred hexagonal arrangement, in view ‘A’ of FIG. 4, accordingly results in a hexagonal formation of such via surfaces and regions of contact surface about each through-hole structure, wherein Sₕₑₓ is the dimension of one side of a resulting hexagon-shaped through-hole perimeter, comprising the center-to-center distance of adjacent regions of contact surface (97), as indicated in view ‘A’ of FIG. 4.

The embodied support structure (17) is formed from a thin metal alloy sheet, which is typically selected from the group of stainless steel types including 300 series, 400 series, ferritic, austenitic, and martensitic steels. Accordingly, the planar support structure (17) is preferably a metal coil, strip, or foil, produced by rolling or other milling procedures common to the art of producing metal foil and strip. The metallic support structure preferably comprises a metal of the compositions and metallic phases suitably matched in thermal expansion properties to the thermal expansion properties of the solid oxide electrolyte. Accordingly, depending upon the specific electrolyte used, the metallic support structure may comprise a stainless steel of austenitic, ferritic, martensitic, or other such metallic phases of commonly available stainless steels, including any of various specialty alloys or equivalents available through commercial producers such as Allegheny Ludlum or Carpenter alloys (e.g., Crofer22 APU, AL453, AL468, 430, 441, 436, Haynes alloys, Hastelloy, Ebrite, etc). For example, in the case that the electrolyte is the preferred stabilized zirconia, such as YSZ, then it is generally preferable that the support structure is of a ferritic or, alternatively martensitic stainless steel; or alternatively, a more expensive specialty alloy, such as any of the various Crofer alloys, may be preferred. Consistent with the prior art of the relevant solid-oxide, thin-film-based, MEA's, MEA's of the present invention will be formed with an according sealing region peripheral to the described electrolytic regions of the MEA's, similar to the MEA's of the aforementioned patent applications by same author.

In accordance with the preferred embodiments, the support structure preferably includes and is protected by the protective coating (2), preferably a 2-3 layer thin film structure that effectively prevents corrosion and oxidizing events that might otherwise deteriorate desired surface characteristics of the support structure. The coating (2) may alternatively serve other purposes, such as increasing an electrical conductivity, or promoting some catalytic process of the electrolytic device. Such coatings are taught in various prior art disclosures, but are preferably those taught in U.S. patent application Ser. No. 11/980,242, by same author. In the present invention, corrosion, or diffusion, barrier coatings comprising a multilayer thin film structure may utilize any number of carbides, borides, or oxides. It is also an alternative embodiment that underlying layers of the coating be electrically non-conductive, such that the electrically-conductive outer layer or layers provide the majority of electrical current. Such latter embodiments are enabled by the relatively compact nature of the disclosed electrolytic cell, wherein the relatively small volume occupied by the cell, combined with large effective electrolyte surface area, allows for smaller current densities to be realized for the same per-unit-volume power generation, or alternatively, oxygen/hydrogen generation.

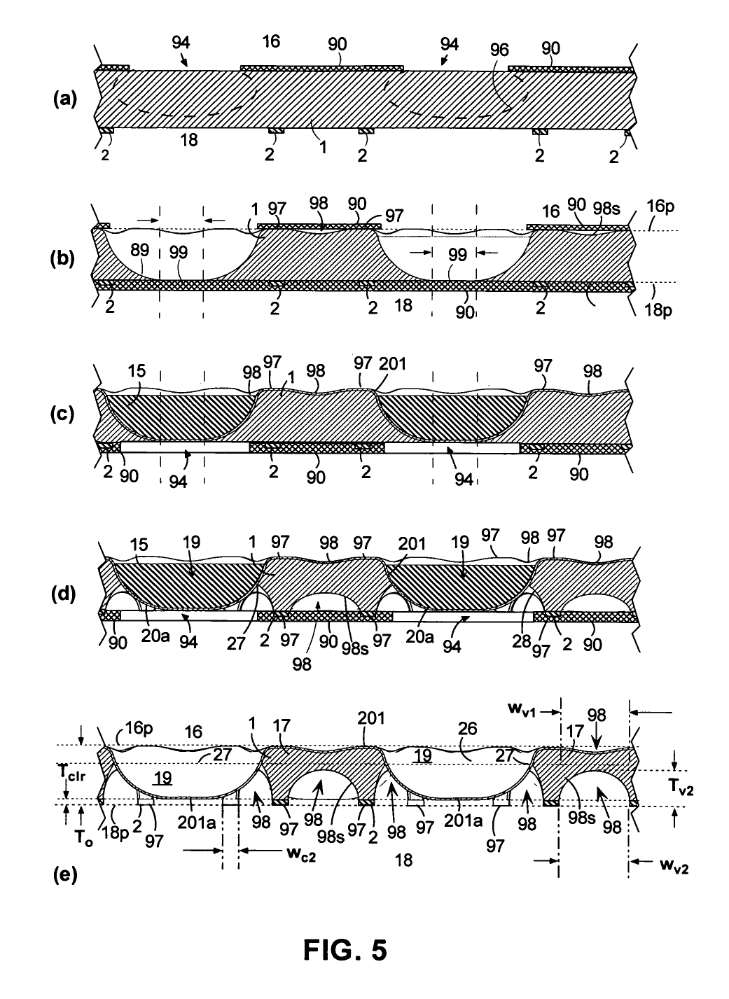

A preferred process for fabricating the previously described support structure (17), in FIGS. 2-4, is described in an embodiment, in FIG. 5, wherein such described features of the preferred support structure are provided in addition to an optional process step that, optionally, may also provide the embodied electrolytic layer of the inventive MEA; though preferred processes that provide the support structure alone are provided presently in accordance with the first preferred embodiments of the present invention.

In its first preferred embodiments, a support structure of the preferred embodiments is fabricated utilizing, in one aspect, substantially isotropic, or roughly isotropic solution-etching processes common to the art of photochemical machining (PCM), so that, whereas a preferred directionality or anisotropy in etch rate may be realized in the etched material, by way of tailoring a flow direction or spray attribute of the etching solution, the etching process is nonetheless preferably characterized by inherently isotropic aspects of an etching fluid. Thin (preferably between 0.002 to 0.020 inches) metal sheet (1) of preferably ferrous alloys—preferably those produced by commercial roller mills—are utilized as starting material for forming support structures of the preferred embodiments. The PCM art is well-developed and it's methods and practices are described in various texts and industry source material, such as those supplied by commercial vendors, Conard, Qualitech Components ltd, Fotofab Corp, the PCM Institute, etc, as well as patent literature of equipment suppliers such as Chemcut Corp.

It is preferred that the support structure provide electronic continuity with one side, either electrode or counter-electrode, of the inventive MEA's. As previously described, such electronic continuity is preferably protected from degradation by means of protective barrier coatings on at least the contact surfaces of the support structure. Accordingly, in the present embodiments, an initial patterned layer of such a protective layer (2) is preferably formed on at least the regions of contact surface (97) on the second side (18) of the metallic support structure, in FIG. 5(a). Such predetermined patterning of the protective layer (2) is readily produced by methods well-known to those skilled in the art of thin film devices, preferably by means of standard lithographic processes used in conjunction with sputter deposition. The patterned protective coating preferably serves as an etch-stop in subsequent etching steps performed on the second side, and is preferably a non-etching conductive oxide, such as a defective perovskite manganate used in prior art protective coatings for SOFC-related structures. The etch-stop accordingly stops etching by the etching solution, in that such protected surfaces are substantially un-etched in subsequent etching steps of the preferred embodiments.

In the preferred embodiments of the present invention, the PCM process is performed in stages, so that one side, preferably the first side (16) of the embodied support structure, is patterned first by the PCM process. As most commonly practiced in the art of PCM, alloy sheets of the present embodiments are patterned with etched features by means of a laminated, or otherwise attached, photoresist (90), wherein the photoresist is exposed to produce a pattern of exposed regions corresponding to the desired etching pattern, as is commonly practiced by those skilled in the art of PCM. In the present preferred embodiments, the photoresist is patterned with the preferred hexagonal array of regions of removed photoresist material (94) providing the corresponding hexagonal pattern of exposed metal surface of the alloy sheet that is subsequently etched for forming recesses on the first side corresponding to the embodied hexagonal pattern of first flared surfaces (26). As is usual in the preferred PCM process, regions of removed resist (94) are centered on the axis of symmetry of the respective through-hole structure to be etched. In the present embodiments, an etching solution of the PCM process, preferably ferric chloride, or alternatively hydrochloric solution, or any other appropriate etchant, is directed to the patterned first side (16) of the planar metal alloy sheet (1) so that concave, roughly hemispherical—or equivalently, roughly hyperbolic, or roughly parabolic—recesses are etched into the alloy sheet.

Of course, since the embodied electrolytic layer comprises the geometry of a thin layer spanning a through-hole feature, whether the cross-section of a particular free-standing electrolytic layer appears substantially convex, or alternatively, concave, will depend upon the orientation of the viewer. Accordingly, in the context of surface shapes formed by thin material layers, convexity and concavity are substantially equivalent qualifications, insofar that such qualifiers distinguish opposing sides of the same material layer.

As is commonly practiced in PCM, it is most preferred herein that the etching of the first side be performed in more than one cycle, so that, for example, a preferred aspect ratio of the electrolytic layer may involve forming an initial pattern of recesses having an initial etched contour (96), provided by a first patterned resist (90), in FIG. 5(a), wherein, in the preferred case that d₁ is roughly 1/100th of an inch, the regions of removed resist (94) of the initial resist layer may be approximately half the diameter, d₁, of the resultant desired through-hole feature on the first side.

A second application of resist (90) on the first side (16) with regions of removed resist (94) corresponding to roughly the diameter, d₁, of through-hole features on the first side, in FIG. 5(b) is provided for etching to the desired profile, approximating the desired smooth and contoured surface (89). Such multiple etch cycles of the first side is preferred for avoiding creation of cusps that might otherwise be formed, though a single etch cycle on the first side may be adequate in some cases.

The etching process conducted on the first side is allowed to continue for a prolonged duration of time, preferably so that the etched recesses are widened to the point of intersecting the opposite side of the sheet, exposing a relatively small region of the photoresist laminated to the second side of the sheet, in FIG. 5(b). Prior to completion of the embodied etching sequence that is performed on the first side (16), it is preferred that the second side (18) is covered by a separate layer of photoresist (90).

Because etching by the PCM process, in the preferred embodiments, is allowed to proceed asymmetrically on the first side of the metal sheet, beyond the extent commonly practiced for achieving through-hole structures in sheet metals, some etch-through is preferably realized, removing metal surfaces previously sealed by the laminated resist (90) on the second side (18). This etch-through, or prolonged etching, preferably results in exposed resist surface (99) at the plane (18p) corresponding to the second side surface of the support structure. Such prolonged etching preferably results as well in the removal of material underneath the existing resist layer on the first side, so that the via surfaces (98s) are formed on the first side in this etching step.

It is preferred that subsequent to the previous etching step wherein roughly hemispheric, concave recesses are formed into the first side of the metal sheet, the remaining patterned resist (90) on the first side, in FIG. 5(b), is removed. An electrolytic polishing step is then employed so that the preferred smooth and contoured surface (89) is provided on the exposed metal alloy surfaces of the formed recesses. Regions of contact surface (97) are preferably polished as well in this polishing step. Accordingly, at this step in the present preferred embodiments, in FIG. 5(b), the smooth and contoured surface (89) preferably intersects the plane of the support structure's second side (18p).

It is thus preferred that, subsequent to the photochemical etching of the first side, in FIG. 5(a-b), a smoothing step, preferably comprising chemical electropolishing, or alternatively, electroless polishing, is performed, in FIG. 5(b), resulting in a surface roughness of the previous etching step being substantially reduced, preferably so that the smooth and contoured surface (89) has a surface roughness of less than 20 microinches RMS, and more preferably less than 5 microinches.

In the preferred embodiments, wherein this latter electropolishing step is performed on previously etched features, it is preferable that 0.10 to 2.0 mil of material be removed, and it is more preferable that 0.25 to 1.5 mil (1 mil=one thousandth of an inch) of material be removed by the polishing step, so that a resultant support structure having a planar thickness of 8 mil would preferably be fabricated from milled alloy strip possessing a planar thickness of 8.25 to 10 mil; or, alternatively, so that a resultant support structure having a planar thickness of 2 mil would preferably be fabricated from milled alloy strip possessing a planar thickness of 2.25 to 4 mil. In some cases it may be preferable that the chemical polishing step be performed with the photoresist on the first side, in FIG. 5(b) still in place, so that less material be removed from surfaces not part of the embodied through-hole structure but instead part of the outermost exposed surfaces comprising the region of contact surfaces (97), which resides immediately under the initial resist patterns (90), in FIG. 5(a-b); and, so that less starting thickness of the material is required for an end desired thickness of the resultant MEA.

Preferred electropolishing recipes for polishing the ferritic stainless steel types of the preferred embodiments, as well as the other stainless steel types found suitable for the embodied support structure, are readily accessible in the prior art of metals finishing. Electrolytic polishing recipes for each of the specific alloys specified herein may be readily found in published texts on the subject. For example, electrolytic polishing compositions, procedures, anode materials, current densities, and polishing times may be found in several of the American Society of Metals Metals Handbook series. e.g. Vol. 2, 8th ed. “Heat Treating, Cleaning, and Finishing.

After electro-polishing the etched surface profile of the previous steps, on the first side, such smooth and contoured surface (89) are preferably covered with an etch-stop preferably comprising a sacrificial resin (15) that will act as an etch-stop during etching of the second side (18) of the support structure, as described in present and later embodiments of the invention.

Preferably, subsequent to filling of the previously formed recesses with sacrificial resin (15), in FIG. 5(c), the photoresist layer (90) covering second side (18) of the alloy sheet is patterned, in FIG. 5(c) so as to form exposed regions (94) in this resist layer, the exposed regions (94) opposite and aligned to the exposed and etched regions previously provided on the first side of the metal sheet, in accordance with normal PCM phototool and lithography practices, and in accordance with the desired hexagonal array of through-hole structures (19), in FIG. 5(c).

In an alternative embodiment of the present invention, there may also be included an alternative intermediate layer (201). Such an alternative intermediate layer may be formed between the embodied polymeric sacrificial material (15) and the smoothed surfaces exposed on the first side after the smoothing step. For example, in one alternative embodiment, the smoothing process step, in FIG. 5(b), may comprise or include an additive process wherein the alternative intermediate layer (201) comprises a smoothing layer. Additive processes such as an electrodeposition or a sputtering step forming a layer of such smoothing layers as tungsten-containing or cobalt containing materials, for example NiCo, may be utilized, in alternative embodiments wherein an additive process is used in place of, or in conjunction with, the preferred subtractive processes, namely electropolishing.

In yet another alternative embodiment, the alternative intermediate layer (201) comprises a material of composition that is not etched by the preferred ferric chloride etching solution, such as in the case that the alternative intermediate layer comprises a silver (Ag) thin film. In such alternative embodiments, the alternative intermediate layer, such as the embodied silver layer, remains after formation of the support structure (17), with its embodied through-hole structures, vias, and regions of contact surface, is complete, so that the alternative intermediate layer may, in certain alternative embodiments, effectively comprise the outer surface of the embodied etch-stop, which remains in place until such features of the support structure are formed, in FIG. 5(d).

After the step of forming the etch-stop structure preferably comprising sacrificial material (15), and in certain alternative embodiments, alternative intermediate layer (201), a second feature-forming etch step is commenced for etching material from the second side, thereby forming the second flared surface (28) of the embodied through-hole structures, in FIG. 5(d). It may be understood by those skilled in the art that implementation of such conformal etch-stop including sacrificial material (15), disposed over the first side of the alloy sheet and first flared surface features formed in the previous step, will allow for prolonged etching applied from the second side without substantially effecting the form or surface morphology of these previously formed features of the first side (16).

In the etching of the second side, the PCM process is once again preferably conducted in more than one cycle, utilizing patterned resist with regions of removed resist (94) centered on the through-hole axes, with a second cycle having wider-diameter regions of removed resist than in the previous cycle, in accordance with well-known PCM practices. Once again, a single PCM of resist/pattern/etch may be adequate in some cases.

The second etching step for forming features in the metal alloy sheet from the second side, in FIG. 5(d-e), results in formation of the second flared surface (28) defining the second through-hole volume (29) on the second side, so that an accordingly enlarged constricting dimension, dₒ, is formed by the receding second flared surface (28).

In accordance with the first preferred embodiments, after the etch step forming features of the second side, in FIG. 5(d), is completed, the polymeric sacrificial material (15) comprising an etch-stop is dissolved away, in FIG. 5(e), by an appropriate solvent, such as by an aromatic hydrocarbon; e.g., xylene. The second photoresist layer (90) from the second side, in FIG. 5(e), is removed, uncovering the contact surfaces (97) of the second side, and exposing surfaces of the second side for subsequent formation of any preferred encapsulation layers or additional surface treatments desired for preserving surface properties of the embodied support structure under intended operating conditions of the intended solid-oxide electrolytic device. In the first preferred embodiment, the support structure surface is coated with an additional protective coating (2) that also covers the newly created flared surfaces (26)(28). In any case, in accordance with the preferred embodiments, the previously embodied support structure, in FIGS. 2-4, is consequently formed, in FIG. 5(c); and, in accordance with an alternative embodiment of the invention, the support structure is optionally formed with alternative intermediate layer (201).

In alternative embodiments that such a non-etching layer is formed, it may provide a substrate for subsequent formation of the electrolytic layer, which may be formed later over first side or second side of the support structure and integral alternative intermediate layer. In the embodied case that the alternative intermediate layer comprises primarily silver, it may then be entirely, or partly, etched away by ferric nitrate solutions, or other such selectively effective enchant, so that the electrolytic layer is consequently exposed on both sides of the free-standing region for formation of desired porous electrode materials. Alternatively, wherein the alternative intermediate layer comprises primarily silver, such silver may be instead be etched or otherwise rendered porous, either by virtue of predetermined ingredients in the primarily silver layer, or by nature of the etch process, so that the silver then becomes a porous cathode material, with corresponding catalytic properties.

In yet another alternative embodiment, comprising the case in which no corrosion-resistant surface coatings or other surface treatments are to be formed over flared surfaces prior to formation of the electrolytic layer, the alternative intermediate layer (201) may include a layer comprising the desired electrolytic layer (20). In accordance with the preferred embodiments of the MEA, the electrolytic layer is alternatively formed first over the smooth and contoured surface (89) so as to be disposed between the smooth surface and the sacrificial material in the present step, in FIG. 5(c).

Accordingly, the resultant free-standing region (201a) of the alternative intermediate layer (201) deposited in such alternative embodiments wherein the alternative intermediate layer includes the electrolytic layer, it will preferably have a central bottom region corresponding, in FIG. 5(b), to the uncovered region (99) that resides at roughly the plane of the second side (18p). In the alternative embodiment wherein an alternative intermediate layer includes the electrolytic layer (20), such uncovered region (99) of the contacting side of the photoresist comprises an alternative sacrificial material in the sense previously attributed to the sacrificial material providing a sacrificial substrate surface for formation of the electrolytic layer.

In alternative embodiments utilizing the previously described alternative intermediate layer wherein the alternative intermediate layer is non-etching in the preferred etching solution, as the second flared surface (28) of the through-hole structure is increased in its diameter, d₂, by progressive etching, the curved sides of the sacrificial etch-stop material (15), with outer surface comprising the alternative intermediate layer, is increasingly exposed to provide an advantageously large and concave, bubble-shaped, free-standing region (201a) of the alternative intermediate layer (201), in FIG. 5(d-e).

Accordingly, the clearance, T_{clr} between the bottom of the free-standing portion of the alternative intermediate layer (201a)and the plane of the corresponding contact surfaces (97) (18p) may be vanishingly small or effectively zero, in FIG. 5(e). Alternatively, as in subsequent alternative preferred embodiments of the present invention, the clearance may comprise some finite distance comprising a fraction of the support structure thickness, Tₒ. As will be understood in conjunction with other embodiments of the invention, the surface region of the free-standing film defined by that formed over the exposed surface (99) preferably comprises a central region of contact surface (100) that is coincident with, or is separated by distance, T_{clr} from, the contact plane of the second side (18p) of the support structure.

It is readily appreciated that the presently embodied process for formation of the support structure is particularly suited for maximizing the second through-hole volume (29), while simultaneously providing means for preserving features of the present invention from over-etching; namely, the first flared surface (26) can be advantageously preserved while maximizing etching from the second side and the corresponding through-hole volume (29) defined by the second flared surface (28) that is formed by the presently described etching step.

It may be readily understood that an alternative intermediate layer need not be formed, in FIG. 5, for the purpose of fabricating the embodied support structure, so that the process steps described, absent of the optional alternative intermediate layer, may be seen to identically provide the embodied alloy support structure, in FIG. 2-4, whereas formation of the alternative intermediate layer, in FIG. 5, is purely optional. The present embodiments comprise primarily those associated with preferred process means for fabricating a support structure in accordance with the preferred embodiments; and, alternatively, means for forming a support structure of the preferred embodiments in combination with a simultaneously formed alternative intermediate layer (201).

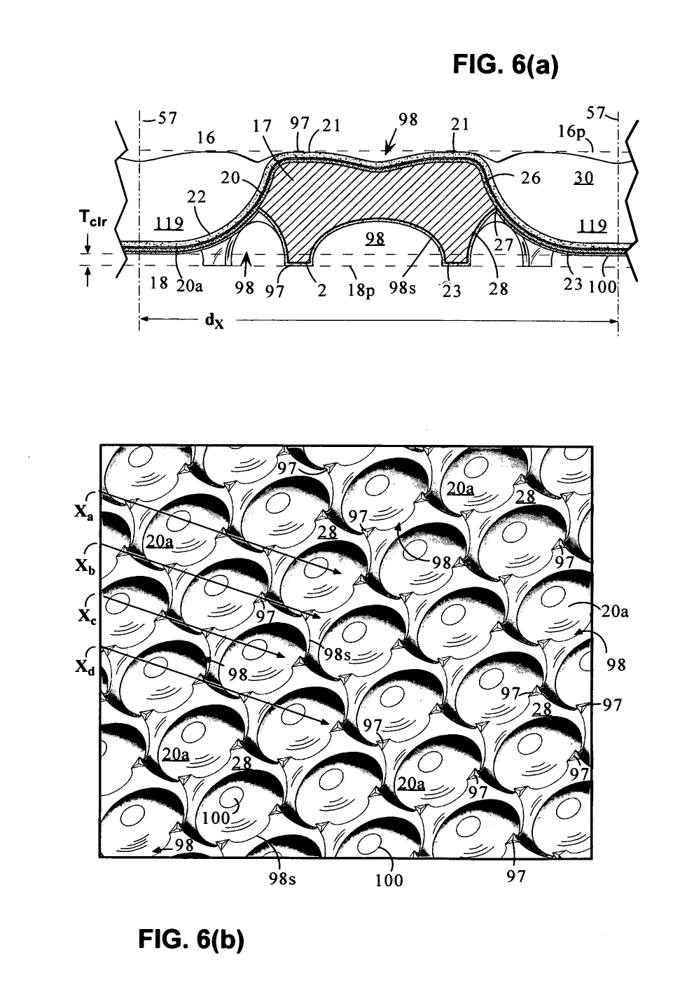

The support structure previously embodied, in FIGS. 2-5, is advantageously utilized as a support structure of the embodied MEA, in FIG. 6, which is preferably fabricated in accordance with processes subsequently described in following embodiments of the present disclosure, though the presently embodied MEA incorporating the inventive support structure may also be fabricated in conjunction with processes and structures previously taught in the prior art.

In accordance with the preferred embodiments, electrolytic layer (20), first porous electrode layer (22), and second porous electrode layer (23) comprising a counter-electrode, are subsequently formed in accordance with the preferred embodiments. Porous electrode layers are formed on opposite sides of the solid oxide electrolytic layer, so that a monolithic electrolytic assembly (30) is formed, wherein such porous electrode layers are preferably formed over first and second sides of the support structure and the integral electrolytic layer previously formed.

Accordingly, solid oxide electrolytes of the present invention may comprise any solid oxide material suitable for providing electrolytic behavior, preferably, those having oxygen ion conductivity's high enough to qualify as a “fast” ion conductor, or alternatively mixed conductor behavior. Accordingly, such solid oxide electrolytes of the present invention may include, but are not limited to, materials containing stabilized zirconia (e.g. Yttria- or rare-earth stabilized), cerium oxides, gadolinium oxides, gallates, manganates, lanthanates, bismuth oxide, and various substituted or mixed oxide compounds. Such solid oxide electrolytes may also have various compositional and morphological properties described in the relevant prior art of thin film processing for such electrolytes, such as nano-crystalline properties, graded compositions, and various dopants.

In accordance with the previously embodied support structure, in the embodied MEA of the preferred embodiments, each through-hole structure is surrounded on first side and second side of the MEA by a plurality of contact pads, with the preferred hexagonal symmetry provided by the support structure, so that six such contact pads are arranged about the periphery of each through-hole structure, in the preferably symmetrical pattern of circular symmetry. Preferably, and in accordance with the previously embodied support structure, the contact pads exist at each point of intersection of the hexagonal array between individual hole structures, wherein a “unit cell” (119) of the hexagonal array comprises the individual repeated unit of the monolithic assembly that exists at each through-hole structure of the completed MEA array.

The clearance, T_{clr}, of the free-standing region (20a) is preferably small so that pixilated contact pads of an adjacent interconnect structure need not be made, or alternatively, need not be made in thickness greater than a two thousandths of an inch, and preferably less, to bridge the clearance, so that an additional contact is provided at central contact region (100). Since the preferred porous counter-electrode layer (23) formed over the second side is preferably formed both over the electrolytic film and the exposed support structure (17) including protective coating (2), such porous layer does not affect such clearance T_{clr}. The porous counter-electrode layer formed over the regions of contact surface (97) of the second side can also provide advantageous compression during the mating of the MEA to an adjacent interconnect, so that small deviations in T_{clr} do not result in substantial differences in electrical communication to the contact pads. Alternatively, the porous counter-electrode layer may be patterned so as to selectively coat the convex aspects of the electrolytic film that are viewable from the second side, in FIG. 6(b), and optionally the adjacent second flared surfaces (28). Such latter embodiments of a selective coating may be realized by way of standard shadow-masking practices in a sputtering chamber.

In the first preferred embodiments, wherein the embodied MEA is utilized in an SOFC cell, with first porous electrode layer (22) comprising an anode layer and second porous electrode layer (23) comprising a cathode layer, it is preferred that the thickness and composition of these porous electrode layers are in accordance with the requirements of the SOFC cell. Accordingly, the thickness' and composition of these layers may vary considerably, depending on the specific requirements and gas compositions of the operating cell. Whereas additional, mechanically decoupled, anode or reformer materials may be utilized in adjacent elements of the completed cell, the thickness of the first porous electrode layer (22) is preferably between 0.5 and 25 μm (micrometers), and more preferably between 1 and 5 μm. The thickness of the second porous electrode layer (23) is preferably between 0.1 and 10 μm, and more preferably between 0.2 and 1.0 μm.

The porous electrodes used may comprise any material previously found effective in the art of solid oxide electrolytic systems. Accordingly, cathode side electrodes may include various cathode materials of the prior art such as LSM, LSM/YSZ composites, LaSrFeO, Pt, or (silver)Ag/TiO_{2, or} any other such porous electrode materials found effective in the prior art of solid oxide electrolytic systems. Anode materials may similarly include any of a variety of materials, including those provided in past solid oxide electrolytic devices, such as heterogeneous metal-oxide/Ni layers, wherein the metal-oxide is similar in composition to that of the electrolyte.

As in previous embodiments, axes X and axes Y are used to designate geometric axes of the hexagonal array. Accordingly, axes Xₐ, X_{b}, X_{c}, and X_{d}, in FIG. 6(b), indicate preferred path direction and specific location of contact surfaces of an adjoining interconnect structure to be aligned along such axes for contacting second side (18) of the embodied MEA, such as a bipolar plate, so that the distance between these indicated axes corresponds to the preferred pitch of linearly grooved channels in a preferred interconnect structure. Accordingly, the distance between such linear contact surfaces separating channels of the interconnect structure preferably corresponds to half the distance between axes X and X′ similarly used in reference to features of the second side of the embodied support structure, in FIG. 4. Equivalently, the pitch of the line spacing in such interconnect structure is such that each linear arrangement of contact surfaces, (97) (100), along a particular axis X on the second side of the disclosed MEA, is contacted by a separate linear contact surface. In the present embodiments, linear contact surfaces of an interconnect plate mated to the inventive MEA, are preferably disposed to contact each of consecutive contact surfaces (97) (100) on the correspondingly contacted side of the MEA. Accordingly, an individual linear contact surface of an adjacent interconnect structure of the preferred embodiments preferably contacts the contact surfaces in paths delineated by such axes, X, in FIG. 6(b).

The central region of contact surface (100) provided on the second side of the embodied MEA structure, which is disposed preferably at the center of the bowl-shaped aspect of the free-standing region (20a) of the electrolytic layer, roughly located centrally with regards to the axis of circular symmetry (57) for the specific through-hole structure in which the central contact surface is disposed. Such contact surface may be observable, under the described preferred fabrication steps, to possess a roughly circular step at its periphery, corresponding to small steps (typically, less than 250 nanometers) that may result from coating the electrolytic layer (20) over similar steps that may exist at the edge of the exposed resist regions (99), in FIG. 5, thereby roughly defining within such step the preferred area of contact.

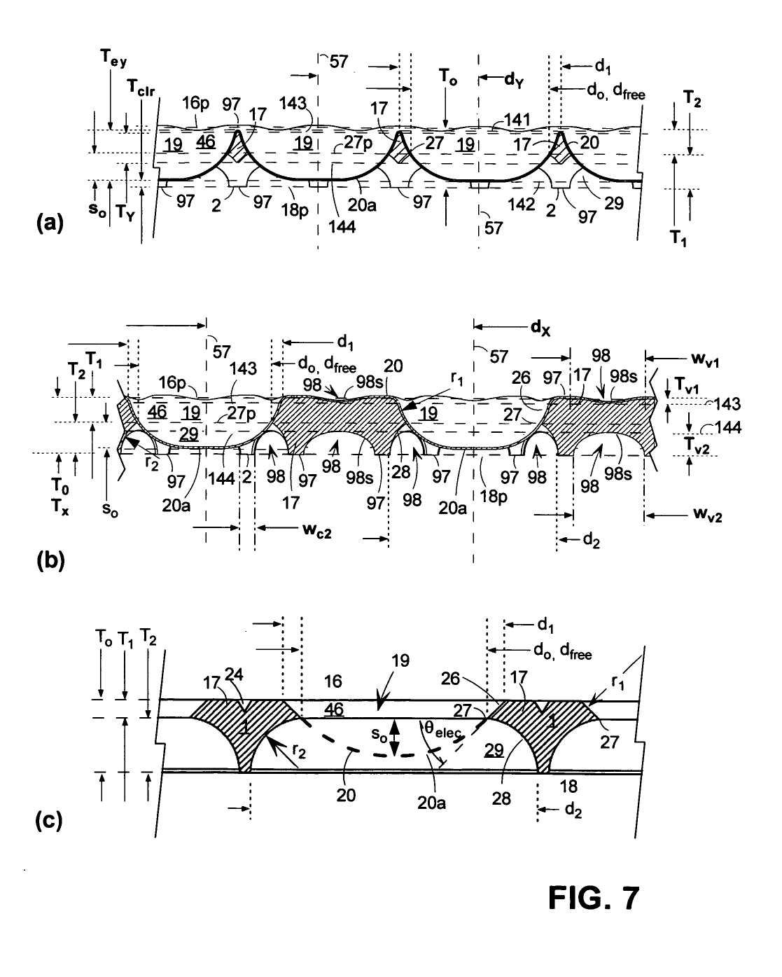

A cross-sectional view of the planar support structure and MEA in accordance with the preferred embodiments, in FIG. 7(a-c), provides various preferred geometric dimensions, with ranges, of the embodied structures in accordance with the preferred embodiments. Sectional side views of the support structure (17) in accordance with the preferred embodiments are detailed, with sectional views taken along an axis Y, in FIG. 7(a), along an axis X, in FIG. 7(b). In addition, a generalized cross-section, in FIG. 7(c), is provided for pointing out further preferred dimensional characteristics of a MEA and integral support structure of the preferred embodiments. Although the preferred dimensional characteristics are provided in conjunction with specific embodiments in the drawings, it will be appreciated by those skilled in the art that various other embodiments may be envisioned within the scope and spirit of the invention, and, the particular features, structures, or characteristics may be combined in any suitable manner in one or more embodiments.

In conjunction with the diagramed cross-sections, in FIG. 7, the thickness, Tₒ, of the planar support structure (17), is provided such that, preferably,
2.5 μm≦T₀≦1000 μm, and more preferably, 50 μm≦T₀≦500 μm, although thicknesses outside this range may readily be envisioned.

The thickness, T_{electrolyte}, of the electrolytic film (20) is preferably less than 10 micrometers (μm), such that preferably,
0.10 μm≦T_{electrolyte}≦10 μm, and more preferably, 0.20 μm≦T_{electrolyte}≦1.0 μm though, thicknesses outside this range may readily be envisioned.

The thickness, or axial depth, T₁, of the smaller first through-hole volume (46) provided within the first flared surface (26) of the through-hole feature is preferred for both providing clearance protection of the free-standing film, as well as for providing a surface for controlled wetting by the sacrificial material in the preferred embodiments. While T₁ may be exceedingly small relative to Tₒ, it is nonetheless of great significance in subsequent processing of the electrode/electrolyte assembly. Accordingly, it is preferred that T₁ be equal or greater than the thickness of the electrolytic film, so that T₁≧T_{electrolyte}, and, so that preferably the free-standing portion of the electrolytic film is found to reside completely within the planes of the first side (16p) and the second side (18). It is accordingly preferred that the smaller through-hole volume (46) has finite thickness, T₁, preferably greater than the thickness, T_{electrolyte}, of the electrolytic film.

Accordingly, the first through-hole volume (46) has finite thickness, T₁, is preferably greater than the thickness of the electrolytic layer (20), T_{electrolyte}, so that, preferably,
T_{electrolyte}≦T₁≦0.5T₀

Also indicated is axial depth, or the thickness, T₂, of the second through-hole volume (29). In accordance with the preferred embodiments, it is preferable that the depth of the greater through-hole volume (29) possess a substantially greater thickness, T₂, than the thickness, T₁, of the smaller through-hole volume (46). The thickness, T₂, of the second through-hole volume, is provided so that, preferably,
0.5T₀≦T₂≦Tₒ, and, more preferably, 0.6T₀≦T₂≦0.9T₀

Wherein, as throughout the present specification, numbers preceding a variable represent a multiplicative factor. Such preferred difference in the thickness of opposing flared regions allows desirable utilization of the overall thickness, Tₒ, of the planar support structure, since the second flared surface (28) defines the size of the second through-hole volume (29), which volume is where most of the free-standing electrolytic film (20a) is preferably disposed.

The clearance between contact plane of second side and active region (20a) of electrolytic film is T_{clr}, wherein, preferably,
0≦T_{clr}≦0.5Tₒ, and more preferably, 0≦T_{clr}≦0.25Tₒ, although, clearances outside of this range are readily envisioned.

The thickness, T_{X}, of support structure member in section taken along an axis X of the inventive support structure, such section described in accordance with the embodiments of FIG. 4, is provided such that, preferably,
T_{X}=Tₒ

The thickness, T_{Y}, of support structure member in section taken along an axis Y of the inventive support structure, such section defined in accordance with the embodiments of FIG. 4, is provided such that, preferably,
0.1Tₒ≦T_{Y}<Tₒ, and more preferably, 0.25Tₒ≦T_{Y}≦0.8Tₒ

The thickness, Tᵥ₁, corresponding to depth of a via formed in the first side of the disclosed MEA support structure in section taken along an axis X of the inventive support structure, such section defined in accordance with the embodiments of FIG. 4, is provided such that, preferably,
0≦Tᵥ₁≦0.4 Tₒ, and more preferably, 0.02 Tₒ≦Tᵥ₁≦0.2 Tₒ

The thickness, Tᵥ₂, corresponding to depth of a via formed in the second side of the disclosed MEA support structure in section taken along an axis X of the inventive support structure, such section defined in accordance with the embodiments of FIG. 4, so that, preferably,
0≦Tᵥ₂≦0.7 Tₒ, and more preferably, 0.1Tₒ≦Tᵥ₂≦0.7 Tₒ

Specific aspects of the inventive MEA may be further understood in conjunction with of the structural features as they relate to the various planes pointed out in the preferred embodiments. There are seven parallel planes defined for pointing out structural aspects of the inventive MEA. These seven planes are substantially parallel to the planar aspect of the original preferred stainless sheet, so that the planes exist at various depths of a sectional side-view of the patterned sheet in conjunction with the embodied support structure, in FIG. 7, taken along axis Y, in FIG. 4.

At a roughly intermediate depth resides the aforementioned plane of constricting surface (27p) roughly corresponding to the position of the edge of the free-standing portion (20a) of the electrolytic layer (20).

On opposite ides of the plane of constricting surface (27p) reside planes of via surfaces (143) (144) delineating depths of via features Tᵥ₁ and Tᵥ₂ of the first and second sides, respectively, and, accordingly, the depth T_{Y}, of metallic cross-members (88) of preferably least-width, w_{cm}.

Outer to these planes of via surfaces (143) (144) reside a second pair of planes, comprising envelope planes (141) (142) of the undulating electrolytic layer (20), so that first pair of planes (143) (144) is preferably contained within the space defined by the second pair of planes (141) (142).

Outer to these planes of envelope surfaces (141) (142) reside a third pair of planes, (16p) and (18p) that are coincident to the outer-most surfaces of the support structure, and so are substantially coincident to regions of contact surface (97) on first and second sides of the embodied planar support structure (17), so that the second pair of planes (141) (142) is preferably contained within the space defined by this third pair of planes, (16p) and (18p), coincident to the outer surfaces of the support structure and separated by thickness, Tₒ.

The term “dimension”, as applied to dimensions, d₀, and d_{free}, of the through-hole features refer to diameters of the preferred roughly circular shape; though, such dimensions may equally well describe such through-hole features in a section taken through the central axis of other through-hole shapes, including but not limited to circularly symmetric polygons, including hexagons, octagons, pentagons, as well as to irregular and oblong shaped through-holes.

In the first preferred embodiments, the free-standing electrolytic film, defined by outer boundary, dₒ, intermediate to first and second sides (16, 18) of the planar support structure, is preferably disposed entirely between planes (16p) (18p) of the first and second sides, so that said surfaces may be applied flush to an adjacent contacting structure—such as a processing drum, mask, or a planar interconnect structure of the electrolytic device—without an undesired pressure to the free-standing portion of the electrolytic film. Such containment is of advantage for subsequent handling and possibly roll-to-roll processing

This lateral constricting dimension, dₒ, in plane of constricting surface (27p), is also the preferred diameter of the free-standing electrolytic film, so that the lateral dimension, d_{free}, in FIG. 7, of the free-standing film (20a) is preferably substantially equal to dₒ, wherein dₒ and the outer dimension of the free-standing film (20a) are coplanar dimensions in a cross-sectional plane, such as is represented in the cross-sectional plane taken normal to first and second surfaces, in FIG. 7.

The lateral dimension, d_{free}, in FIG. 7, of the free-standing film (20a), is provided such that, preferably, d₀=d_{free}

The smallest constricting dimension, d₀, is preferably the diameter of preferred circular through-hole structure at its constricting surface (27) the constricting diameter preferably measured in the intermediate plane of constricting surface (27p). Along such axes Y as defined in conjunction with the embodiments of FIG. 4, methods provided herein in conjunction with the inventive PCM-based processes and structures, the pitch may be substantially reduced with respect to that normally achieved in the PCM art. Accordingly, dₒ can equal an unusually large percentage of d_{y}; in particular, the through-hole constricting dimension, d₀, of the through-hole structures, is provided so that, preferably,
25 μm≦dₒ≦1250 μm, and more preferably, 50 μm≦dₒ≦500 μm

though dimensions outside this range may readily be envisioned; and, dₒ, may vary considerably depending upon T₀, so that, preferably,
0.5T₀≦d₀≦2.0T₀, and more preferably, 0.8T₀≦d₀≦1.5 T₀

The pitch d_{y} of hexagonal array along axis Y wherein distance measured between adjacent axes of central symmetry of adjacent through-hole structures, is provided so that, preferably,
0.50d_{y}≦dₒ≦0.92d_{y}, and more preferably, 0.80 d_{y}≦dₒ≦0.89 d_{y}

d₁ and d₂, of the through-hole opening at the first surface and second surface of the planar support structure, respectively, are both preferably greater than dₒ. Accordingly, when the through-hole volumes, for example, the second through-hole volumes (29) are widened to the extent, as in the preferred embodiments, that such second volumes intersect, then the respective hole diameters, d₂, would be accordingly measured between the remaining contact surfaces (97) diametrically positioned about the respective through-hole volume. The diameter d₁ of preferred roughly circular opening of through-hole structure (19) at the first surface (16p), is provided so that, preferably,
1.1 dₒ≦d₁≦3.0dₒ, and more preferably, 1.1 dₒ≦d₁≦2.0 dₒ

The diameter d₂ of preferred roughly circular opening of through-hole structure (19) at the second surface (18p), is provided so that, preferably,
1.2 dₒ≦d₂≦3.0dₒ, and more preferably, 1.2 dₒ≦d₂≦2.2 dₒ

The width of the via features in the second side, wᵥ₂, are substantially greater than the largest lateral dimension, w_{c1}, of contact surface segments (97) on the first side (16), so that preferably wᵥ₁>wᵥ₁. Also, largest lateral dimension, w_{c1}, of contact surface segments (97) on the first side (16) is preferably larger than the corresponding largest lateral dimension, w_{c2}, of contact surface segments on the second side (18)

The width wᵥ₁ of the via features in the first side, wᵥ₁, is provided so that, preferably,
0<wᵥ₁≦300 μm, and more preferably, 10 μm≦wᵥ₁≦150 μm

The width wᵥ₂ of the via features in the second side, is provided so that, preferably,
0<wᵥ₂≦400 μm, and more preferably, 25 μm≦wᵥ₂≦200 μm

The largest lateral dimension, w_{c1}, of contact surface segments (97) on the first side (16), preferably equal to length of one side of the preferred triangular contact surface, is provided so that, preferably,
5 μm≦w_{c1}≦200 μm, and more preferably, 25 μm≦w_{c1}≦100 μm

The largest lateral dimension, w_{c2}, of contact surface segments on the second side (18), preferably equal to length of one side of the preferred triangular contact surface, is provided so that, preferably,
5 μm≦w_{c2}≦125 μm, and more preferably, 12 μm≦w_{c2}≦75 μm

Comparison is made to prior art PCM methods, wherein cross-members, or “bars” that separate hole features are conventionally required to have minimum widths of at least 80-90% of the material thickness: in contrast to embodiments of the present invention, wherein such cross-members, w_{cm} are defined as width of the cross-member features in FIG. 4, as determined by sectional width of such cross-members (88) in view ‘C’ in FIG. 4, is provided so that, preferably,
10% T₀≦w_{cm}≦80% T₀, and more preferably, 15% T₀≦w_{cm}≦60% T₀

Launch angle θ_{elect} is the angle of tangent to electrolytic layer at point of contact to constricting surface (27), in a sectional plane containing through-hole axis of circular symmetry (57), in FIG. 7(c), the angle measured with respect to plane of constricting surface (27p), so that, preferably,
0°≦θ_{elect}≦90°, and more preferably, 10°≦θ_{elect}≦80°

The flared surfaces of the through-hole features may comprise any of a variety of widened profiles. Such various profiles comprise those of chamfers, bevels, fillets, etc., and are generally regarded herein as a subset of all flared surfaces that may comprise the side-walls of roughly circular or circularly symmetric through-holes, and wherein a straight, angled chamfer, as represented in herein, may be seen to be simply a subset of radius-ed fillets having an infinite radius (i.e., a flat profile). A variety of such fillet surfaces are found to be readily formed through the preferred photochemical machining methods. The use of such a fillet surface allows for the constriction surface to provide a relatively small angle of intersection, θᵢₙₜ, so that preferably θᵢₙₜ is less than 120° (degrees), and more preferably less than 90°, wherein this angle represents the angle between the two fillet surfaces at the intersection. This angle is of relatively greater importance in the preferred embodiment that the constriction surface comprises substantially an edge of intersection between the first flared surface and the second flared surface,

In the preferred embodiment that the flared surfaces (26) (27) possesses a cross-sectional profile that is essentially curved, in FIG. 7, in the manner of a fillet, such fillet surfaces have an effective fillet radius, r₁, of the first flared surface (26) of the planar support structure, and most preferably, an effective fillet radius, r₂, of the second flared surface (28) of the planar support structure. In such embodiments with a substantial fillet radius, the fillet radius is defined herein as that radius that may be determined by measuring the maximum sag of the fillet, relative to the respective edges of the fillet surface; namely, the relevant edges providing the dimensions, dₒ, d₁, or d₂. The qualifier “effective” is intended to point out that such fillet radii may deviate from a circular profile, so that the average surface profile designated by radii, r₁ and r₂, may possess parabolic, hyperbolic, roughened, or other non-circular characteristics while still being formed with a net sag in its the profile, as indicated in FIG. 7.

It is particularly preferable that the second flared surface (28) is formed with a radius so that working gases may more freely access such three-phase-boundary regions of the free-standing electrolytic layer (20a) that are closest to the surface of constriction (27). It may be found adequate, in some cases, to provide only the greater through-hole volume (29) provided within the second flared surface (28), without forming the smaller flared surface, so that the thickness, T₂, of the greater through-hole volume is substantially equivalent to Tₒ, though it is preferable, under these circumstances that the effective r₂ be relatively small, preferably less than four time the thickness of the planar support structure, such that r₂≦4Tₒ, whereas, in the case that a smaller flared surface is provided, r₁ may be more broadly defined, and may be quite large, or essentially infinite, corresponding to a straight profile.

The effective fillet radius, r₁, of the smaller flared surface (26) of the planar support structure, is provided so that, preferably,
0.1Tₒ≦r₁≦∞, and more preferably, 0.5Tₒ≦r₁≦4.0Tₒ

The effective fillet radius, r₂, of the greater flared surface (28) of the planar support structure, is provided so that, preferably,
0.1Tₒ≦r₂≦10Tₒ, and more preferably, 0.5Tₒ≦r₂≦4.0Tₒ

The effective displacement, sₒ, or sag, of a free-standing surface of the electrolytic film from planarity, preferably displacement being that from the plane of constricting surface (27p), is provided so that, preferably,
0.02<sₒ/dₒ<2.0, and more preferably, 0.05<sₒ/dₒ<0.5.

As mentioned earlier, it is preferable that dₒ=d_{free}, so that d_{free} is therefore most preferably defined by the constriction surface (27), though the principles and advantages set forth herein may be less preferably realized provided that d_{free}<d₂

The effective displacement from planarity, sₒ of the convex (or, concave) aspects of the disclosed free-standing electrolyte portions typically lie in a range, and is provided so that, preferably,
2 μm<sₒ<1250 μm, and more preferably, 25 μm<sₒ≦250 μm

The free-standing portion of the electrolytic film can be provided as an adequate stress relieving structure by providing that the ratio, sₒ/d_{free}, of effective displacement, sₒ, to the lateral dimension, d_{free}, of the free-standing electrolytic film, be sufficient to allow suitable flexure of the free-standing film during the temperature changes (typically 27 C-800 C) required for operation of the device, preferably such that 0.02<sₒ/d_{free}<2.0, and more preferably, 0.05<sₒ/d_{free}<0.5. As mentioned earlier, it is preferable that dₒ=d_{free}, so that d_{free} is therefore most preferably defined by the constriction surface (27), though the principles and advantages set forth herein may be less preferably realized provided that d_{free}<d₂, and adequate clearance for controlled wetting by the sacrificial material is found to be also provided under the preferable condition that d₂−d_{free}≧0.25 Tₒ.

The free-standing electrolytic film, relative to the periphery of the free-standing region, possesses a net convex aspect. Such convex aspect may be defined by an effective displacement, sₒ, or sag, of a free-standing surface of the electrolytic film from planarity. Once again, it is pointed out that “sag” is defined in its conventional meaning, wherein it refers to a displacement distance, measured roughly from the center of a surface or aspect thereof, by which a surface is curved from planarity. For example, the free-standing electrolytic film may possess various aspherical characteristics; however, an estimated radius of curvature may be obtained by measuring the sag, sₒ, across the lateral dimension, d_{free}, of the free-standing electrolytic film, where dₒ=d_{free} in FIG. 7, so that an estimated radius of a corresponding roughly spherical surface of equivalent sag is provided, as is commonly performed in conjunction with mechanical sag-measuring devices used in measuring ground or polished surfaces.

It is noted herein that a convex surface feature having a sag, sₒ, may comprise any one or a combination of surface figures. For example the functionally convex/concave surface of the disclosed electrolytic film may be incorporated in a Gaussian aspect, a bell-curve, a sinusoidal aspect, a parabolic aspect, a hyperboloidal aspect, or any other aspherical aspect, without departing from the scope and spirit of the present invention. Such alternative surface shapes may be regarded as acceptable, insofar as such shapes satisfy the stated objective of the present invention, which is to provide a convexity in the surface of the free-standing electrolytic film, so that the free-standing film may be strained or flexed by a changing hole dimension, relative to the free-standing film, without fracture of the film.

For example, the figure of the film may be provided as hyperbolic, elliptical, spherical, aspheric in any fashion, symmetric, asymmetric, continuous, non-continuous, eccentric, wavy, or any other profile that enables the film to span and seal the hole, so as to provide leak-free performance that is desired for the solid oxide electrolytic devices addressed herein. Convex or concave aspects may comprise a variety of spherical, aspherical, creased, or an otherwise non-planar cross-sectional figure that provides flexibility by virtue of the ability of the electrolyte to flex. The free-standing electrolytic film may be provided with a variety of irregular aspects having the embodied concave/convex aspect, wherein aspects of the free standing film may depart from concentricity.

The term “free-standing” shall, in the present invention, refer to the region of the electrolytic layer (20) that is not directly attached to the alloy support structure on either of its opposing sides. In other words, the free-standing region (20a) of the electrolytic layer is that portion of the layer that spans the opening of the through-hole structure (19), without regard to any adjacent electrode layers that may be formed or otherwise extant on either side of the free-standing region.

The free-standing portion (20a) of the electrolytic film is the portion of electrolytic thin film that is left free-standing over the through-hole feature, so that the film may flex in response to temperature changes. Such ability to flex defines an advantage of the free-standing characteristic of the film. Consistent in the present disclosure will be the embodiment of a free-standing electrolytic film, wherein the free-standing film is defined as such by virtue of being not attached to the alloy support structure.

### Area

In the present preferred embodiments, it is therefore possible to provide substantially great portion of the planar area of the MEA to the free-standing portion of the electrolytic film, insofar as the instant invention provides means for substantially increasing the usable area over that normally provided for in the art of photochemical machining.

Furthermore, the fabrication of the free-standing region of the electrolytic thin film of the present embodiments, wherein the free-standing portion is provided with substantial sag, or concavity, further increases available area of the free-standing electrolytic film.

Accordingly, d₀/2=(¾)Sₕₑₓ so that Aₒ>0.5 Aₕₑₓ and preferably=0.68 Aₕₑₓ

The active planar area of the planar metal sheet that is subsequently patterned with the embodied periodic grid, so as to consequently comprise the active area of the embodied MEA,

The repeating unit of the preferred, periodic, hexagonal array, corresponds to the “unit cell” of the MEA, which is accordingly provided at one through-hole structure (19) of the embodied support structure. This repeating unit comprises a corresponding hexagonal unit of area, Aₕₑₓ. Accordingly, Aₕₑₓ is the average planar area per through-hole structure in the preferred hexagonal array, wherein Sₕₑₓ is side of hexagonal area, so that this area is:
Aₕₑₓ=[(Sₕₑₓ)² 3√3]/2, so that, the area is preferably, 1×10⁻⁶ inch²≦Aₕₑₓ≦2.6×10⁻³ inch², and more preferably, 4×10⁻⁶ inch²≦Aₕₑₓ≦4.1×10⁻⁴ inch²

Aₒ=The planar area, in FIG. 4, defined by surface of constriction (27) with diameter dₒ roughly coincident with plane of constricting surfaces (27p), so that Aₒ=(d₀/2)^{2 l π=(d}₀)² π/4, and so that, preferably,
0.40 (Aₕₑₓ)≦Aₒ, and, more preferably, 0.60 (Aₕₑₓ)≦Aₒ≦0.80(Aₕₑₓ)

A_{free} Surface area of electrolytic thin film actively transporting oxygen ions, or equivalently, that portion of the electrolytic thin film disposed between opposing porous electrode layers, is equivalent or greater in surface area, measured by its predetermined figure, than the planar area of the support structure on which this active area is disposed.

A_{free}=The surface area of free-standing portion of electrolytic film, as defined by diameter dₒ of the free-standing region, and sag describing deviation of film aspect from planarity; e.g., in the roughly limiting condition wherein free-standing region is substantially a concave bowl-shaped surface with sag, sₒ, of sₒ=dₒ/2 or roughly so, the surface of the free-standing region will correspond to roughly that of half of a sphere, then

A_{free}=(1/2)4(d₀/2)²π)=2(sₒ)²π=(dₒ)² π/2

so that for an MEA of the preferred embodiments, it is possible to have a free-standing electrolytic film with average area greater than the corresponding area of the planar region of the MEA devoted to the free-standing electrolytic film, or equivalently A_{free}>0.68 Aₕₑₓ. It is preferred, therefore, that the area of the freestanding electrolytically active membrane area, A_{free}, so that, preferably,
0.5(Aₕₑₓ)≦A_{free}≦2(Aₕₑₓ), and more preferably 0.7(Aₕₑₓ)≦A_{free}≦1.5(Aₕₑₓ)

The following examples provide demonstration of the increase in percentage open area (Aₒ/Aₕₑₓ×100%) of the preferred embodiments over prior art embodiments, as well as the according percentage increase (A_{free}/Aₕₑₓ×100%) in a “maximum” surface area of the free-standing region (electrolytically active regions) of the embodied MEA, which will here correspond to the area of a half-sphere of diameter d₀ for comparison.

### EXAMPLE 1

### Calculated Percentage Open-Area of Prior Art PCM Support Structure

The maximum percentage of open area (AₒAₕₑₓ×100%) in a photo-chemically machined (PCM) hexagonal grid of the prior art is calculated in accordance with the limiting factors widely recognized in that industry. Accordingly, bar widths, w_{cm}, are generally required at a minimum of 80%, and in some instances greater, of material thickness; and hole width, d₀, are provided at a minimum of d₀/Tₒ≧. Under such conditions

$$\begin{matrix}{A}_{hex} = [ {( {S}_{hex} )}^{2} 3 √ 3 ] / 2 \\ = \text{∼} 2.6 {( {S}_{hex} )}^{2} = \\ = 2.6 {( 0.94 {d}_{0} )}^{2} \\ = 1.03 {( {d}_{0} )}^{2}\end{matrix}$$

$$\begin{matrix}{A}_{o} / {A}_{hex} = \frac{{( {d}_{0} )}^{2} π / 4}{2.3 {( {d}_{0} )}^{2}} \\ = \text{∼} 0.34 , and , therefore ( {A}_{o} / {A}_{hex} \times 100 \% ) \\ = 34 \%\end{matrix}$$

### EXAMPLE 2

### Calculated Percentage Maximum Surface Area Provided with Prior Art PCM Support Structure

Utilizing such prior art PCM grids in conjunction with the concave/convex electrolytic layers the embodied MEA, with the surface figure of the free-standing electrolytic layer corresponding to the limiting case of a half-sphere:

$$\begin{matrix}{d}_{0} = ( 0.8 / O .750 ) {S}_{hex} \\ = 1.07 {S}_{hex} ;\end{matrix}$$

$$0.94 {d}_{0} = {S}_{hex}$$

$$\begin{matrix}{A}_{hex} = [ {( {S}_{hex} )}^{2} 3 √ 3 ] / 2 \\ = \text{∼} 2.6 {( {S}_{hex} )}^{2} \\ = 2.6 {( 0.94 {d}_{0} )}^{2} \\ = 2.3 {( {d}_{0} )}^{2}\end{matrix}$$

$$\begin{matrix}{A}_{free} / {A}_{hex} = \frac{{( {d}_{0} )}^{2} π / 2}{2.3 {( {d}_{0} )}^{2}} \\ = \text{∼} 0.68 , and , therefore ( {A}_{tree} / {A}_{hex} \times 100 \% ) \\ = 68 \%\end{matrix}$$

### EXAMPLE 3

### Calculated Percentage Open-Area of Embodied PCM Support Structure

$$\begin{matrix}{d}_{0} / {S}_{hex} = 1.1875 / 0.75 \\ = 1.58 ;\end{matrix}$$

$${d}_{0} = 1.58 {S}_{hex} ;$$

$$0.63 {d}_{0} = {S}_{hex}$$

$$\begin{matrix}{A}_{hex} = [ {( {S}_{hex} )}^{2} 3 √ 3 ] / 2 \\ = \text{∼} 2.6 {( {S}_{hex} )}^{2} \\ = 2.6 {( 0.63 {d}_{0} )}^{2} \\ = 1.03 {( {d}_{0} )}^{2}\end{matrix}$$

$$\begin{matrix}{A}_{o} / {A}_{hex} = \frac{{( {d}_{0} )}^{2} π / 4}{1.03 {( {d}_{0} )}^{2}} \\ = \text{∼} 0.75 , and , therefore ( {A}_{o} / {A}_{hex} \times 100 \% ) \\ = 75 \%\end{matrix}$$

### EXAMPLE 4

### Calculated Percentage Optimized Surface Area Provided with Embodied PCM Support Structure

Accordingly, given enlarged d₀ possible in the referred embodiments, we find that for

whereas

$$\begin{matrix}{A}_{o} = {( {d}_{0} / 2 )}^{2} π \\ = {π [ ( 3 / 4 ) {S}_{hex} ]}^{2} \\ = ( π 9 / 16 ) {( {S}_{hex} )}^{2} \\ = 1.77 {( {S}_{hex} )}^{2} \\ = \text{∼} 0.68 {A}_{hex}\end{matrix}$$

$$\begin{matrix}{d}_{0} = ( 1.1875 / O .750 ) {S}_{hex} \\ = 1.583 {S}_{hex} ;\end{matrix}$$

$$0.63 {d}_{0} = {S}_{hex}$$

$$\begin{matrix}{A}_{hex} = [ {( {S}_{hex} )}^{2} 3 √ 3 ] / 2 \\ = \text{∼} 2.6 {( {S}_{hex} )}^{2} \\ = 2.6 {( 0.63 {d}_{0} )}^{2} \\ = 1.03 {( {d}_{0} )}^{2}\end{matrix}$$

$${A}_{free} = {( {d}_{0} )}^{2} π / 2$$

$$\begin{matrix}{A}_{free} / {A}_{hex} = \frac{{( {d}_{0} )}^{2} π / 2}{1.03 {( {d}_{0} )}^{2}} \\ = \text{∼} 1.53 , and , therefore ( {A}_{free} / {A}_{hex} \times 100 \% ) \\ = 153 \%\end{matrix}$$

Accordingly, as evidenced in the above examples, substantial increase (from 34% to 75%) in open area of the support structure, as well as a substantial increase (from 68% to 153%) in surface area of the free-standing electrolytic layer, is provided by the inventive PCM methods and embodied MEA structures of the present invention.

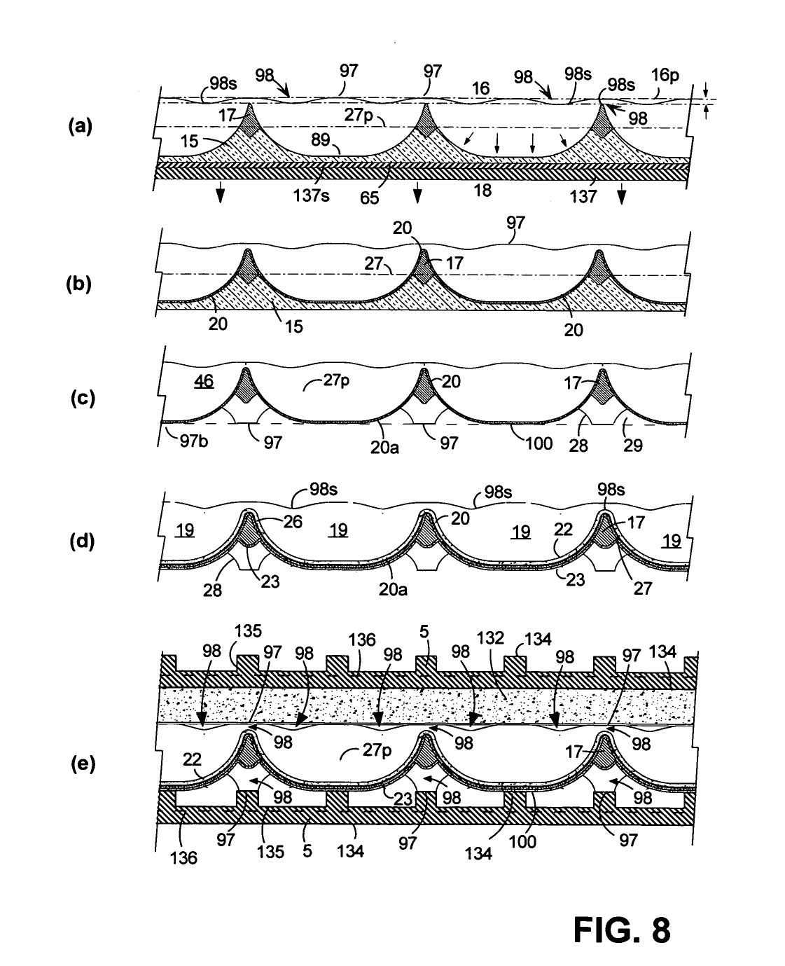

It will be understood by those skilled in the art that meaningful assessments of surface area, for calculating effective working cell area herein, are informed by the geometric area of the electrolytic layer, as discussed herein, rather than by surface morphology calculations based on nanometer-scale pore structures or similar such surface-roughness calculations.

Whereas the support structure of FIGS. 2-5 and FIG. 7 may be formed and processed by various means to comprise a support structure integral to an MEA, including those processes of the prior art, preferred processes are embodied herein for advantageously providing an MEA of the present invention. In the preferred embodiments, a support structure of the preferred embodiments, in FIG. 2-4, is infiltrated with a sacrificial resin (15), in FIGS. 8, to provide at least part of the smooth and contoured surface (89), thereby similarly providing the resulting surface and shape over which the electrolytic layer is formed.

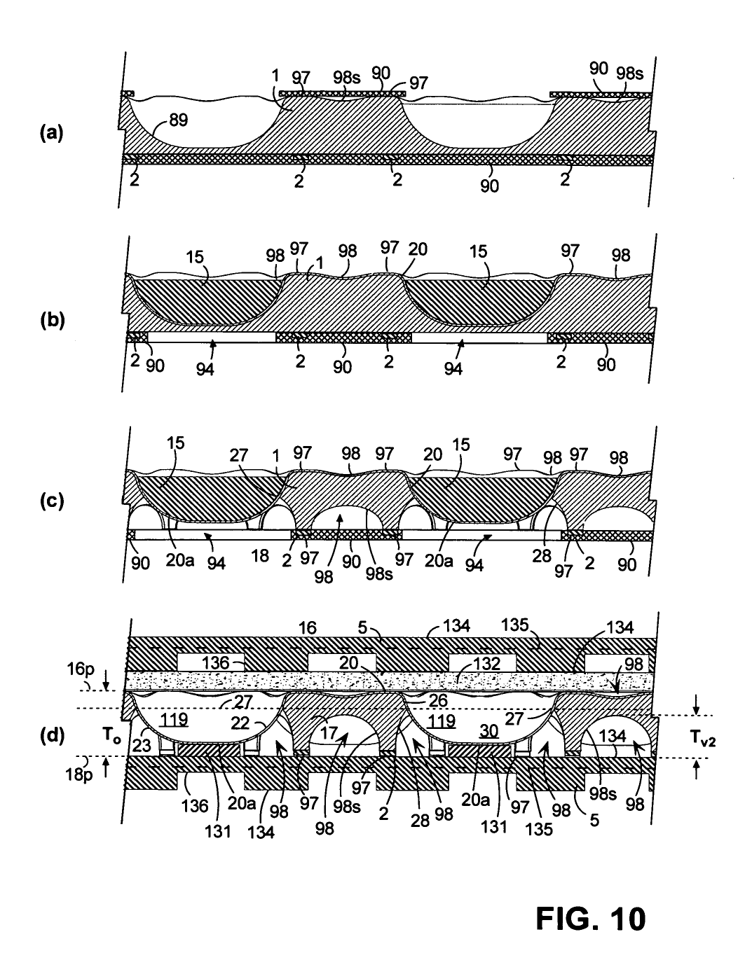

In a first preferred embodiment of the present invention, described in conjunction with sectional views taken along an “axis Y” of the embodied support structure, the electrolytic layer of the invention is formed in steps subsequent to the formation of the support structure (17) in previous preferred embodiments, in FIGS. 2-5. Whereas alternative processes are pointed out for producing the solid oxide electrolytic layer during formation of the embodied support structure, in FIG. 5 and FIG. 10, it is generally preferred, as in the present preferred embodiments, that the electrolytic layer is formed subsequent to forming the preferred features of the support structure.

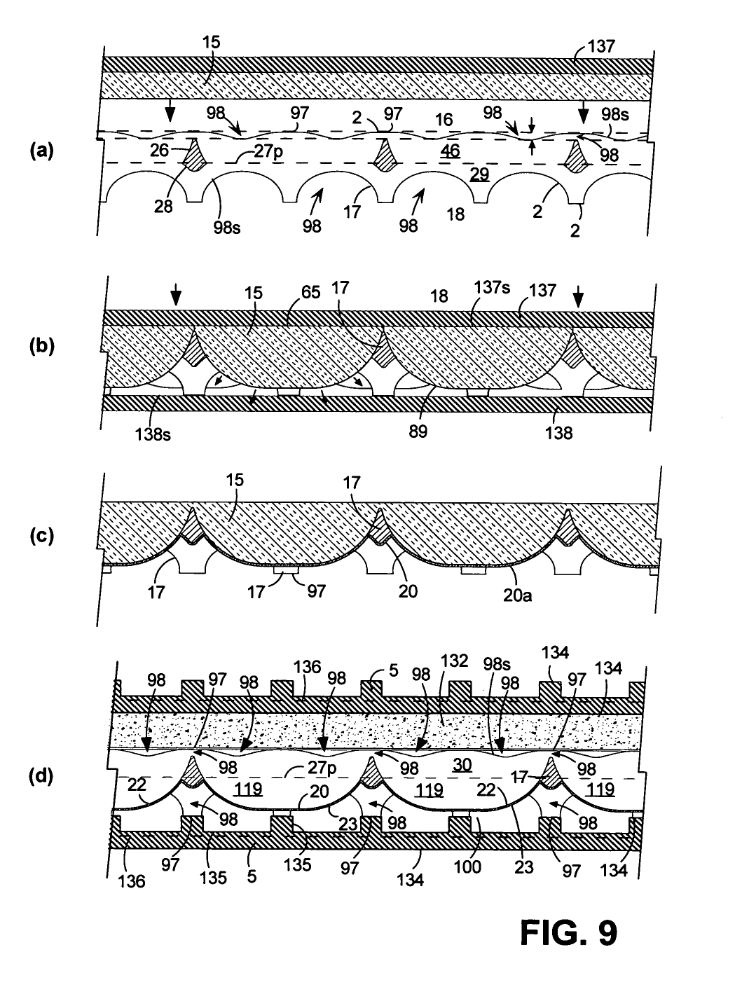

Accordingly, a support structure of the preferred embodiments is utilized, in FIGS. 8-9, to provide preferred methods that enable the support structure to be subjected to encapsulation coatings, surface treatments, and desired modifications that are best applied before forming the electrolytic layer. Such embodiments, in FIGS. 8-9, additionally provide fabrication methods whereby using electro-polishing chemicals of relatively high environmental cost or hazard may be reduced or avoided. Use of polymeric resins as the sacrificial material (15) over which the electrolytic layer (20) is formed is also preferred as advantageous in regards to reproducibility and environmental issues encountered in manufacturing and chemically polishing the preferred 400-series stainless steel sheet or coil, where desirably smooth surface morphology of the sacrificial material (15) is not as susceptible to process history of the alloy sheet as in later alternative embodiments of the invention wherein the sacrificial material and smooth contoured surface (89) comprise primarily electropolished surfaces of the alloy sheet (1).

Furthermore, it is sometimes preferred that the interface between the free-standing electrolytic layer (20a) and the constricting surface (27) not be sharply defined by an accordingly sharp interface between the first flared surface (26), second flared surface (28) and the surface of the electrolytic layer that faces the second side (18) of the support structure, but is rather de-coupled by means outlined in earlier disclosure by same author, in U.S. patent application Ser. No. 11/906,044, wherein an over-wetting margin is provided by a polymeric sacrificial material.

In the embodiments of FIG. 8-9, the sacrificial material that fills the through-holes is preferably an organic material, and more preferably a homopolymeric material, such as polyethylene, or alternatively copolymer having a suitably low glass transition temperature, T_{g}, so that the polymer may be readily wetted to the planar structure. Various texts have become available during the previous several decades describing the rheology, wetting characteristics, and compositions of organic polymers used for lamination of metal surfaces and topographies, so that various such organic resins may be substituted with similar performance.

A mold plate (137) providing a mold plate surface (137s), such surface preferably comprising a planarized and polished surface terminated with a coating or treatment of low surface energy suitable for allowing removal of the mold plate from the set resin (15), in FIG. 8(a), is utilized to provide means of infiltrating the preferred polymeric resin into through-hole structures from the second side (18) of the support structure. Similar to prior art embodiments, there may also be utilized a secondary polymeric material (65) outer to the first that further enables handling and/or delamination.

The sacrificial material (15) comprising a layer of polymeric resin is initially introduced to the support structure at its flow temperature, for instance, in the preferred case of a polyethylene homopolymer, at a temperature of around 100 C (Celsius) is adequate. Preferably sufficient resin is evenly distributed on the mold plate, preferably with detachable interlayer (65) in an accordingly thin layer, typically between 10 and 100 microns, depending on precise clearance of the support structure. For example, the preferred polyethylene homopolymer resins co-extruded or alternatively laminated with a Mylar sheet are available commercially in a large variety of multi-layers for various applications for providing heat-sealable films and delaminating surfaces. Alternatively, vapor deposition used in the related art on web coating, wherein similar resins are formed onto polymer webs, provide similar multilayer sheets that may comprise the layers of sacrificial material (15) and handling polymer (65).

The thickness of sacrificial resin (15) introduced into the second side of the support structure forms a wetting level approximately corresponding to the plane of the constricting surface (27p). After such wetting up to the line of constricting surface (27), the mold plate is preferably reversed in direction to be pulled away from the support structure so as to be displaced a distance equivalent to that required to provide a smooth and contoured surface (89) by means of the surface tension of the resin in conjunction with its wetting of the support structure, preferably so that the concave surface of the set resin has a bottom level corresponding to T_{clr}.

The sacrificial resin (15), preferably an organic resin such as polyethylene homopolymer, provides the smooth and contoured surface (89) of concave aspect similar to previous embodiments. Such concave aspect of the sacrificial resin is preferably implemented by way of an appropriate pressure differential applied with respect to opposite sides of the infiltrating resin, preferably wherein the pressure differential will preferably exist between the first side of the support structure and the side of the mold plate opposite the sacrificial material. The pressure differential may vary widely, but is preferably less than 10 psi, and provided by an inert and filtered gas such as argon, wherein the pressure is preferably provided by positive pressure, though such differential may alternatively be provided by vacuum differential as well. Such inert gas is provided to the first side, by such flat grid or porous elements as commonly used for wafer vacuum chucks. Once the resin surface has receded back to the desired concave surface, in FIG. 8(a), the sacrificial resin is then allowed to set, and mold plate is preferably removed at this point. Various means of delaminating of the set polymer from the mold plate may be utilized, including any of the method used in prior art for delamination of polymer resins. Preferably delamination is enabled by a low surface-energy material, such as preferably a PTFE layer, or other such release layers at the interlayer (65), so that the set sacrificial resin (15) is left intact.

Using the preferred vapor deposition means, and more preferably, sputtering processes, the preferred stabilized YSZ, or other preferred electrolytic layer (20) is formed over the first side, in FIG. 8(b) so as to cover the resulting continuous surface comprising concave smooth and contoured surface (89) provided by the sacrificial material and remaining exposed portions of the support structure viewable from the first side.

The sacrificial material (15) is then dissolved away by an appropriate solvent, such as by an aromatic hydrocarbon like xylene, in FIG. 8(c), thereby exposing the free-standing electrolytic film on both sides. As in previous embodiments, it is preferable and advantageous that stress relieving structures comprising the convex, free-standing portion of the electrolytic film be disposed entirely between planes comprising the first and second surfaces of the metallic support structure, so that the free-standing electrolyte is thus relatively protected within the respective through-hole feature in which it is formed. As in previous embodiments, the sacrificial material is removed so as to result in the embodied solid oxide electrolytic layer supported on the interior surfaces of constriction (27), with free-standing regions (20a), in FIG. 8(c).

In a process step preferably subsequent to removal of the sacrificial material, porous electrode layer (22) and porous counter-electrode layer (23) are formed over first side and second side of the support structure, in FIG. 8(d), in accordance with preferred vapor deposition methods previously outlined in previous disclosures by same author, or alternatively by any compatible method of the prior art, so that such layers are intimately in contact with the solid oxide electrolytic layer in accordance with the well-known requirements of such MEA interfaces. In an alternative embodiment, first porous electrode layer (22) may be formed previous to removal of the sacrificial material (15).

Once the embodied MEA, comprising support structure (17) with integral electrolytic layer (20), porous electrode and counter-electrode layers (22) (23) and preferably protective layers (2), is completed in accordance with the previous preferred embodiments, the MEA is preferably incorporated into an electrolytic stack comprising a plurality of such MEA's and interleaved interconnect plates, as common in the art of solid oxide electrolytic stacks.

In addition to the first porous electrode layer (22) and second porous counter-electrode layer (23), it may be preferable to also incorporate additional porous electrode material into a cell, such as in the case that an anode-side reformer material is desired in considerably greater thickness than what is practical for such porous electrodes that are preferably thin and conformal to the electrolytic layer. Such an additional porous electrode is accordingly not conformal to the electrolytic layer, and is preferably disposed as a mechanically decoupled porous electrode layer (132), in FIG. 8(e).

The MEA structure (30) resulting from previous steps of the presently embodied process is assembled into layers of a solid-oxide electrolytic device, in FIG. 8(e), in a manner common in the prior art of SOFC fabrication, comprising a periodic assembly of a solid-oxide electrolytic stack including bipolar interconnect layers (5), preferably fashioned from thin metallic sheets, and preferably, in addition, fuel reformer layers comprising the decoupled porous electrode layer (132), so that the first side of the embodied MEA is, in the current first preferred embodiments, the anode side of an SOFC cell. Although such decoupled porous electrode layers may be found advantageously utilized in the anode of cathode side, or both sides, of either SOFC or OGS devices.

As is common in bipolar interconnect plates of the prior art, such interconnect structures (5) of the present embodiments have channel features (136) providing gas flow and electrically contacting cell features corresponding to the first side, or electrode, of the inventive MEA, and opposing channel features (135) formed on opposite side of the interconnect for contacting elements of an adjacent cell corresponding to the second side, or counter-electrode, of an adjacent MEA. Accordingly, such channels preferably provide gas flow means in the operation of solid-oxide electrolytic cells on the respective sides of the interconnect plate (5) as commonly practiced. In the present embodiments, flow channels (136) disposed for contacting the first side of the inventive MEA preferably run parallel to the axis Y so that contacting surfaces between these channels are provided for contacting the second porous electrode opposite the described regions of contact surface (97). However, any variety of flow channel means and manifolding arrangements of the prior art may be employed.

In regards to channel features (135) providing gas flow and electrical contact to the second side of the embodied MEA, such channel features preferably run parallel to axis X, in FIG. 4, so that contact surfaces (134) are disposed for providing electrical contact to the embodied MEA both at regions of contact surface (97) formed in the integral support structure, as well as at central regions of contact surface (100). In the preferred case that the embodied MEA is incorporated in a SOFC device, such contacting to the second side will comprise cathode side of the SOFC cell. The via spaces (98) defined by first side via surfaces (98s) in conjunction with a secondary decoupled porous reformer layer (132), provide additional means for gas-phase communication in between adjacent unit cells (119) of the resultant MEA.

In the preferred embodiments incorporating a polymeric sacrificial material, it may be readily understood that a variety of wetting behaviors and resultant sacrificial material shapes are possible for providing a substrate for subsequent deposition of the electrolytic film. While it is a preferred embodiment that the sacrificial material be disposed so as to deposit electrolytic material over the first side of the planar support structure, it may be readily understood that it is equally possible provide the convex free-standing elements of the present disclosure by wetting sacrificial material to the first side of the planar support structure, the sacrificial material disposed so as to form the electrolytic layer over the second side of the planar support structure, wherein the electrolytic film accordingly acquires the shape of a preferred convex meniscus formed by the sacrificial material.

Therefore, in the present alternative preferred embodiment, the solid oxide film (20), in FIG. 9, is accordingly deposited on the sacrificial material and planar support structure from the second side of the planar structure. The resultant electrolytic film (20) with free-standing region (20a) is thus formed in an alternative embodiment, in FIG. 9, in that the film of the present alternative embodiment is formed on the same side of the planar substrate as the convex aspect of the free-standing portion (20a) of the electrolytic film, or equivalently, on the same side as the second flared surface (28).

In the present alternative preferred embodiment of process steps for fabricating MEA's of the preferred embodiments, a support structure in accordance with the preferred embodiments, in FIGS. 2-4, is again utilized, with process steps described in conjunction with sectional side view taken along an axis Y of the support structure.

Similar to previous process embodiments, in FIG. 8, mold plate means (137) provide a polymeric resin for infiltration of the support structure from one side, and in the present embodiments, in FIG. 9(a), mold plate with sacrificial resin (15) is introduced to the first side of the support structure (17), so that, the sacrificial polymeric resin (15) is infiltrated into the support structure. The resin is cooled and set to provide the smooth and contoured surface (89) providing the preferred aspect of previous embodiments, only with an inverse, or convex surface provided instead of the concave polymer surface of the previous preferred embodiments, the convex surface accordingly shaped for providing a similar profile in an electrolytic layer as that of the free-standing region of the electrolytic layer (20a) in previous embodiments. In addition, it is preferable that a second mold plate (138) is provided at the second side (18) of the support structure for contacting and registering against the contact surfaces provided at the regions of contact surface (97). The second mold plate (138) preferably provides opposing force for extrusion of the polymeric resin to form the desired convex shapes for a predetermined clearance T_{clr} of a subsequently formed electrolytic layer (20), thereby similarly providing the resulting shape over which the electrolytic layer is formed.

In accordance with the present embodiment, the first flared surface (26) provides a surface on which the sacrificial material is preferable disposed, so that the first flared surface provides a wetting surface for the wetting resin. In the present embodiment, it is preferable that the sacrificial material again be disposed over the planar support structure as a compound structure that includes materials, wherein one layer is a secondary polymeric material (65) that is preferably of a polymer of different glass transition temperature, T_{g}, than the transition temperature of the, preferably polymeric, sacrificial material (15) that fills the through-hole structure.

Once the polymeric resin (15) is set and mold plates are removed, the electrolytic layer (20) is formed, similarly to previous embodiments, over the resulting piece-wise continuous surface that is now viewable from the second side of the support structure, in FIG. 9(c).

As in previous embodiments, the sacrificial polymeric material is preferably removed, as in previous embodiments, after its function as a sacrificial material is served, in FIG. 9(d), so that the subsequent porous electrode layers (22) (23) may then be formed on the opposing surfaces of the electrolytic layer's free-standing region (20a) as well as corresponding exposed sides of the support structure. As in previous embodiments, the resultant MEA is assembled with other elements of a cell, including bipolar interconnect plates (5), and any decoupled porous electrode layers (132).

In yet another alternative preferred embodiment, the support structure is formed simultaneously to processes forming the electrolytic layer, wherein some or all of the etching performed from the second side of the support structure may be performed after formation of the electrolytic film, in FIGS. 10, so that the solid oxide electrolytic film comprises an etch-stop similar to the previous alternative embodiment, in FIG. 5, wherein the alternative intermediate layer (201) comprises the electrolytic layer (20). Such methods are seen as preferred in instances where the operating temperature is sufficiently lowered (typically <600 C), the operational lifetime requirements sufficiently low, and/or such specialty alloys as Crofer, Plansee, etc, become economically viable in the preferred form of thin alloy sheets, so that requirements of the protective coating are substantially eased.

In certain cases, such as in the case wherein the alloy support structure comprises a specialty steel and the solid oxide electrolytic device is to be operated in a low to intermediate temperature range, preferably below 600 C, it may be possible to forego utilization the encapsulating protective coating (2). In such latter cases, it may be then possible to also forego the step of forming the sacrificial regions from a polymeric sacrificial material, and to use the original alloy material, in its place, as the sacrificial material on which the freestanding portion of the electrolytic film is formed. Accordingly, in the alternative embodiments of FIG. 10(a-e), the preferred photochemical machining process is utilized to first form the preferred concave aspects within the original alloy structure, so that the function of the sacrificial material is served by the alloy material and smoothed surfaces (89).

In the present alternative embodiments, in FIG. 10(a-e), in sectional views corresponding to those taken along an axis X in FIG. 4, the preferred chemical etching of the first side provides concave recesses, similar to embodiments described in conjunction with FIG. 5(b), except preferably without etching through to the other side (18p) of the metal sheet. In the present alternative embodiments, the sacrificial material preferably comprises the corresponding regions of the original metal alloy sheet, so that the entire smooth and contoured surface (89) is formed in the alloy material, in FIG. 10(a). Accordingly, etched recesses formed into the first side of the alloy sheet are preferably treated with a subsequent smoothing step similar to the electropolishing step of previous embodiments, thereby providing the smooth and contoured surface (89). Additive processes, similar to those described previously, in FIG. 5, may also be utilized in the present smoothing step.

In the present embodiments, etching of the metal alloy sheet, in FIG. 10(a), is thus preferably performed in similar manner as outlined in the embodiments of FIG. 5(a-b), except that the prolonged etching step performed on the first side is sufficiently short in duration that no etch-through to the second side (18) has occurred.

The support structure (17) in the present embodiments also preferably provides electrical communication with contact surfaces of the second side, which are preferably the cathode side of an SOFC cell, though the corresponding electrode may alternatively be the anodic or cathodic side of either an SOFC or OGS cell. Accordingly, it is also preferred, in the present embodiments, in FIG. 10, similar to the embodiments of FIG. 5, that the original alloy material of the support structure (17) be coated with protective layer (2) in selected regions, provided, at minimum, on the second side regions corresponding to the region of contact surfaces (97), which is opposite the side receiving the electrolytic layer (20) in the present embodiment.

The electrolytic layer (20) is then formed over the smooth and contoured surface (89) as in previous embodiments. The solid oxide electrolyte (20) is formed, in FIG. 10(b), as a layer in accordance with the preferred vapor deposition means, the layer formed over the resultant modulated surface of the alloy, thereby forming the preferred relief structure in the electrolytic layer, similarly to the previous embodiments,

Subsequent to the formation of the electrolytic layer (20) in accordance with the preferred embodiments, in FIG. 10(b), it is preferred that a protective sacrificial resin (15) is then provided on top of the electrolytic layer as a sacrificial material for maintaining, during subsequent processing, the desired roughly hemispheric shape—or equivalently, roughly hyperbolic, or roughly parabolic shape—that was previously formed during the previous etching and polishing steps of the present embodiments. In some cases, the sacrificial resin (15) may instead be substituted by a porous electrode layer of the preferred embodiments.

Preferably the second sequence of patterned photo-resist (90) with removed regions (94) is performed on the second side after the chemical polishing step performed on the smooth and contoured surface (89) on the first side. The second side of the resultant compound polymer/metal structure, in FIG. 10(a-c) is preferably laminated with photoresist and patterned for processing the second side of the alloy sheet, as in previous embodiments, wherein subsequent patterning of the photoresist will be aligned to the previously formed array of concave surfaces as in previous embodiments.

The second side of the planar sheet of alloy material (1) may then be chemically etched to expose the free-standing electrolytic oxide layer (20a) by the second photochemical machining step, so that according elements of the earlier embodied monolithic assembly may once again be formed, in FIG. 10(c). Etching of the second side, in FIG. 10(c), is cat tied out in a manner essentially the same as outlined in the previous embodiments, so that, similarly, the free-standing portion (20a) of the electrolytic film is exposed on the second side and residing in the now-formed second through-hole space (29); and, so that, accordingly, second flared surfaces (28) with integral via surface (98s) defining resultant via (98) are also formed.

As in the previous embodiments, the polymeric resin (15), as well as resist (90) on the second side are removed, so as to, as in previous embodiments, provide the integral assembly of electrolytic layer and support structure, which can then be over-coated on its respective sides with the porous electrode layers, so as to provide a similar MEA structure as previously embodied. As in previous embodiments, the electrode/electrolyte assembly, in FIG. 10(d), is subsequently processed as in previous embodiments, to form electrode layers, preferably including patterned conductor layers (21), and opposing porous electrode layers (22) (23) that comprise anode and cathode of the resultant MEA, whether utilized as a SOFC, OGS, or a combination device providing both functions alternatively, preferably by providing electrolytic transfer of oxygen across a layer of metal oxide material.

Assembled cells additionally include contact pads (131) formed over contact surfaces (134) of the bipolar interconnect plates, the contact pads providing electronic connection between counter-electrode (23) and interconnect plate. Such contact pads typically comprise screen printed contact pads, preferably of the preferred counter-electrode electrode material including appropriate catalyst, such as a porous defective perovskite or Pt-containing refractory material consistent with the cathode requirements of a SOFC device.

In the present alternative preferred embodiments, the clearance, T_{clr}, is finite, and on the order of less than 0.010 inches, more preferably, less than 0.005 inches, and even more preferably, less than 0.001 inches, so that screen printing may be utilized readily for such conductive pads of equivalent thickness', and so that the clearance space, T_{clr}, is bridged by such contact pads. As in prior art embodiments, and in any embodiments herein, it is alternatively possible, and may be preferred under some circumstances, to provide no contact means for contacting central contact region (100), so that electrical continuity to the embodied MEA (30) is primarily provided across the previously embodied contact surfaces comprising regions of contact surface (97). Other pointed out elements of the embodied electrolytic cell, in FIG. 10(d), are assembled similarly to previous electrolytic cells of the preferred embodiments.

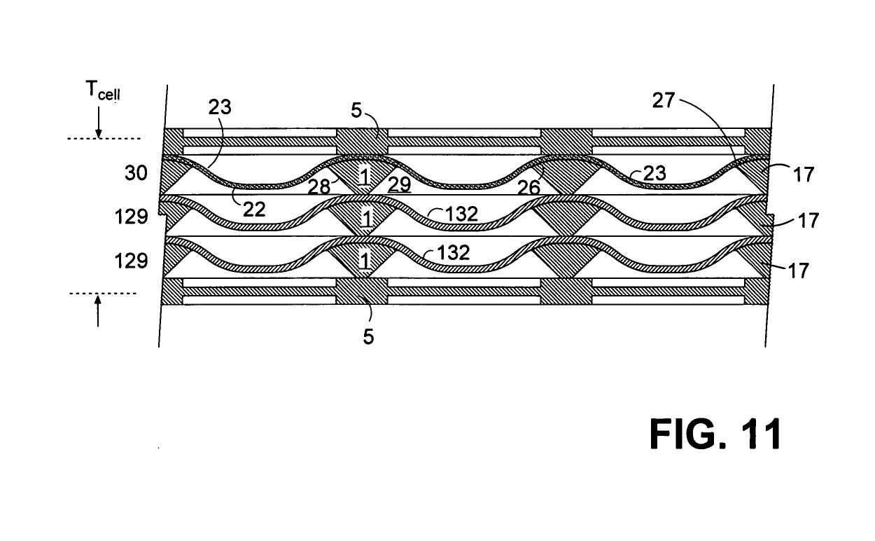

In addition to the thin electrode structure formed over the electrolytic structure of previous embodiments, it may be preferable, in a further embodiment, to utilize a second support structure (17) in conjunction with additional porous material layers that are not compatible, either mechanically or chemically, with the materials of the MEA (30). In such latter cases, an additional decoupled porous layer (132) of preferably catalytic material may be disposed adjacent to the electrode/electrolyte assembly so as to enable an additional functionality, such as fuel reformation for SOFC operation, in the resultant device. Alternatively to previous planar embodiments of a decouple porous layer, a decoupled porous reformation layer (132) of the preferred embodiments, in FIG. 11; may be formed in an similar manner as that prescribed for formation of the electrode/electrolyte assembly, accordingly utilizing similar sacrificial materials to achieve flexure-enabling relief structures in accordance with the preferred embodiments. It is thus possible to incorporate one or more additional porous layers of functional material, such as the porous reformation layer, within a cell of the present invention, wherein such a porous layer does not contact the free-standing portion of the electrolyte, and is thus mechanically de-coupled from the flexible electrolyte that resides in the through-hole structure of the electrode support structure. Such monolithic decoupled porous electrode assemblies (MDPEA), comprising the earlier embodied support structure (17) with decoupled porous layer (132), are also advantageous in allowing a decoupling of the process for creating the porous reformer layer from the process of forming the electrode/electrolyte assembly, before ultimately joining these two monolithic assemblies, MEA (30) and MDPEA (129), in an electrolytic cell. In some cases, such as when the interconnecting bipolar plates are made with etched manifold structures providing gas flow channel features (135, 136), it may be alternatively preferred to form the porous reformer layer directly over such manifold structures, such as by first filling the manifold channels with sacrificial material of the preferred embodiments, forming the porous reformer layer over the manifold structure, and then removing the sacrificial material.

In addition, it may be seen in the present embodiments utilizing thin cell thickness, T_{cell}, of preferably 5-50 mil, in accordance with the embodied metal thickness' utilized, that relatively low areal power density may be obtained in the individual cells, in terms of power/unit area, whereas the power/unit volume can remain high. In such embodiments, it is preferred that the volumetric power density, Pᵥₒₗ, be such that Pᵥₒₗ>1 watts/cm³, and more preferably Pᵥₒₗ>4 watts/cm³, whereas the area power density Pₐᵣₑₐ, as determined by planar dimensions of the active regions, preferably be Pₐᵣₑₐ<0.2 watts/cm², and more preferably Pₐᵣₑₐ<0.1 watts/cm², though, of course, power densities well outside these ranges may be advantageously realized, and may accordingly be at typical levels considered desirable in prior art SOFC systems. Because of the relatively large density of electrolyte surface area per unit volume, in the present preferred embodiments, such increase surface area may provide additional means for improved adsorption of process gases of the electrolytic device to the electrolyte surface, so that such adsorption augments gas displacement through the device insofar as such adsorption is a pumping mechanism. Such augmentation of gas displacement may be found advantageous for decreasing or, in some cases, eliminating some requirements of auxiliary blowers or other mechanical gas pumping means. Electrolytic devices of the present invention may be operated with total pressures greater than, equal to, or below atmospheric pressure, whereas utilizing the improved adsorption means of the present embodiments may provide particular advantage when either anode or cathode side of the device is operated at sub-atmospheric total pressures, whereby such lowered total pressure might enable drawing of desired device gases through gas-specific selection membranes.

As cited earlier, there is no particular requirement that the disclosed planar electrolytic devices be constructed as circular, square, rectangular, polygonal, elliptical or other shape previously found suitable for planar electrolytic cells of the prior art. In fact, it may readily be appreciated that the electrode/electrolyte assembly of the present invention may be readily be incorporated into any of a variety of prior art solid-oxide electrolytic cell design, including various gas distribution schemes, sealing solutions, and interconnects of the prior art. In particular, it is preferred that the MEA's of the preferred embodiments are utilized in conjunction with circularly symmetric SOFC, or alternatively, OGS, solid oxide cell stacks of aforementioned US patent applications by same author, wherein circularly concentric stacks are provided with concentric gas flow manifolding for providing radial flow of the operating gases.

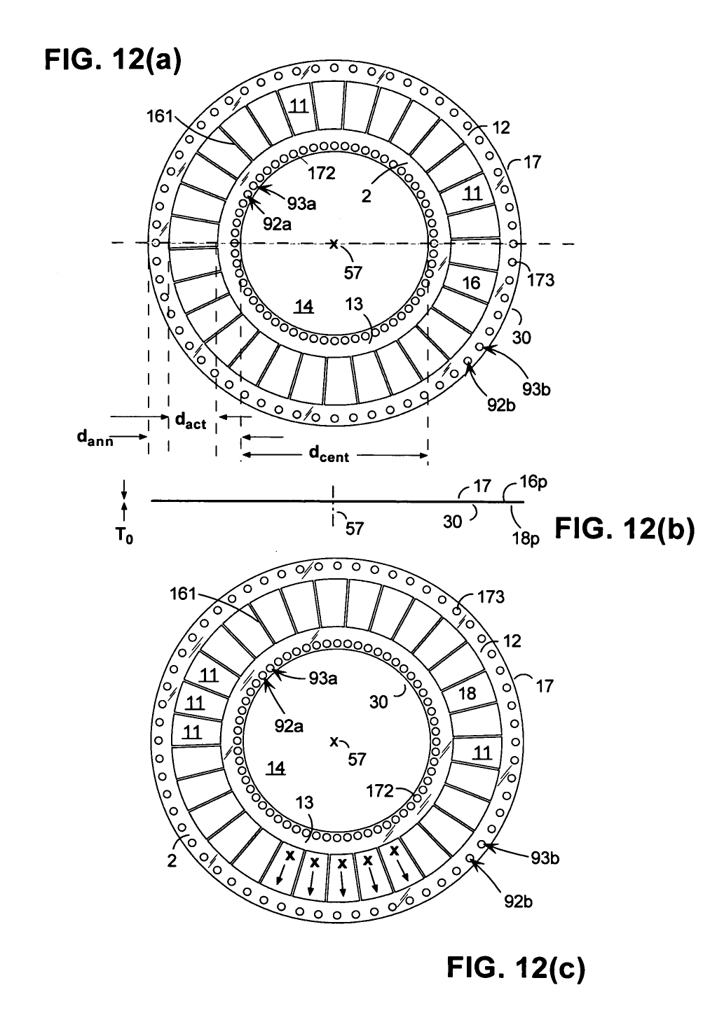

As in previous disclosures by same author, cited herein, it is most preferred that the embodied solid oxide MEA and associated cell structure be disposed in an annular configuration, so that SOFC stacks, or alternatively OGS stacks, are formed as effectively hollow cylinders. Preferred embodiments of such a hollow cylindrical SOFC stack, in FIGS. 12-17, provide additional features and advantages in such an annular SOFC stack.

An MEA of the preferred embodiments, comprising thin stainless steel support structure (17) and electrolytic layer (20), has, in general, three regions viewable from a top plan view, including an annularly disposed active region (11), an inner annular sealing region (13), and an outer annular sealing region (12). As in earlier embodiments, the active region of the MEA incorporates the supported electrolytic layer and supporting grid structure, whereas the two sealing regions comprise inner and outer sealing regions wherein is preferably provided surface means for introducing or removing the operating gases of the SOFC device.

A plurality of inner manifold through-hole features (172) are formed in the inner sealing surface (13) of MEA support structure (17), so that these inner through-hole structures preferably provide air-side manifold passages (93a) for air/steam/oxidizer supply, and fuel-side manifold passages (92a) for fuel supply.

A plurality of outer manifold through-hole features (173) are formed in outer sealing (12) surface of MEA support structure (17), so that these outer through-hole structures provide air-side manifold passages (93b) for air/steam/oxidizer return, and fuel-side manifold passages (92b) for fuel return.

A plurality of inner manifold through-hole features (172) and outer manifold through-hole features (173) are formed in the inner and outer annular sealing regions (13) (12) respectively of the MEA, so that such manifold through-hole features provide manifold passages that alternately comprise fuel manifold passages (92) and oxidant manifold passages (93), wherein preferably, the fuel supply passages (92a) and oxidizer (comprising air, steam, or oxidizing gas) supply passages (93a) are located within the inner annular sealing region (13); whereas, the fuel return passages (92b) and oxidizer return passages (93b) are preferably located in the outer annular sealing region (12) and accordingly provided by outer manifold through-hole features. It is preferable that barrier coatings are provided on the preferred stainless steel support structure (17) in accordance with the preferred embodiments. In accordance with he required maintenance of an electrically insulating barrier between the cathode and anode of the MEA, the sealing regions are accordingly also coated by an electrically isolating thin film coating, which is preferably in the same process by which the electrolytic layer is formed, and may be an identical or similar electronically insulating material.

In accordance with previous embodiments, the annular MEA comprises thin stainless steel sheet of thickness, T₀,

FIG. 12(b), wherein the thickness of the annular MEA is that of the preferred thin metal sheet, with thickness T₀,

The central hole (14) of the annular MEA, is defined by the inner concentric edge of the embodied annular MEA, and more particularly, the inner edge of the inner annular sealing region (13) is preferably provided with an inner diameter d_{cent},

The preferred annular active region (11) of the embodied annular MEA in the present embodiment is preferably formed as an annularly disposed active region, and more preferably as a segmented active region comprising an annular array, such annularly disposed active region intermediate to the concentric inner sealing region (13) and concentric outer sealing region (12), with annular width, d_{act}, of the active region. The annular width, dₐₙₙ, of the resulting annular MEA thus comprises these three regions, in FIG. 12(a).

Furthermore, it is preferred that the annular active region of the embodied MEA be segmented by radial cross-member lines (161) comprising narrow, non-patterned regions that extend between inner and outer sealing regions of the annular MEA, so that the annular active region substantially comprises a plurality of segmented regions separated by non-patterned linear regions comprising the cross-member lines. Such cross-members (161) preferably provide an interface between distinctly oriented active segmented regions, so that, preferably, major axes of the patterned array of each segmented active region segment, such as axis X in FIG. 4, are each oriented in a substantially radial direction, with respect to the MEA's axis of circular symmetry (57), in FIG. 12. In the particularly pointed out embodiment, there are thirty such segmented regions of the embodied MEA active region, though the number and shape of the segments may vary considerably.

Accordingly, in the preferred embodiments, wherein the annularly disposed active region comprises an arrangement of segmented sections, preferably the preferred hexagonal pattern of the MEA, or alternatively, other regular pattern, it is preferably formed with a major axis of each segment radially oriented with respect to the central axis of symmetry (57) of the MEA.

Opposite sides of the embodied MEA, in FIG. 12(a) and FIG. 12(c), are preferably identical in the geometric dimensions of all features that border the active region, namely those features of the inner and outer sealing regions.

The annular width, d_{act}, in centimeters, is provided such that, preferably,
0.05 cm≦d_{act}≦50 cm, and more preferably, 1 cm≦d_{act}≦10 cm

although values outside this range may be envisioned.

The annular width, dₐₙₙ, in centimeters, is provided such that, preferably,
0.1 cm≦dₐₙₙ≦55 cm, and more preferably, 2 cm≦dₐₙₙ≦15 cm

although values outside this range may be envisioned.

The annular width, d_{cent}, in centimeters, is provided such that, preferably,
0.1 cm≦d_{cent}≦50 cm, and more preferably, 1 cm≦d_{cent}≦10 cm

although values outside this range may be envisioned.

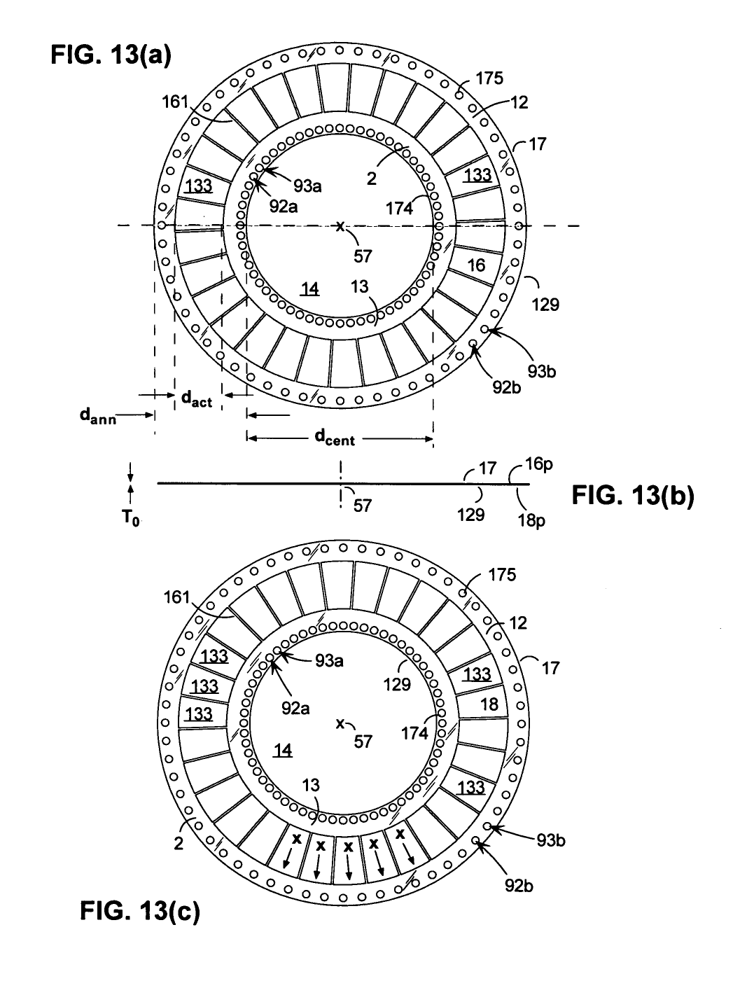

An annular embodiment of a monolithic decoupled porous electrode assembly (MDPEA) in accordance with a preferred embodiment, in FIG. 13(a-c), incorporates a MDPEA active region (133), which comprises the active region of the monolithic decoupled porous electrode assembly embodied previously, in FIG. 11, including a support structure (17) with decoupled porous electrode layer (132). The MDPEA (129), similar to the previously embodied MEA, comprises, in general, three regions comprising annularly disposed MDPEA active region (133), an outer annular sealing region (12), and an inner annular sealing region (13), such MDPEA active region comprising that region of the MDPEA formed so as to be positioned adjacent to the active regions (11) of the previously embodied annular MEA, as previously embodied in FIG. 11. These three MDPEA regions are preferably provided with roughly equal dimensions to the corresponding dimensions of the MEA. Accordingly, the support structures provided for the MEA and preferably incorporated MDPEA of a SOFC cell are substantially identical in the first preferred embodiments; though, just as the support structure of the MEA may vary considerably in the present invention, so may any particular MDPEA support structure vary considerably in its features or dimensions with respect to an MEA support structure in the same cell. Furthermore, it is not intended that such annular regions be restricted to strictly circular regions, as various polygonal arrangements of the segmented active regions or sealing regions may be readily envisioned

As previously embodied, the support structure of the monolithic decoupled porous electrode assembly (129), or MDPEA, substantially repeats, or alternatively mirrors, the support structure of the MEA (30), as embodied in FIG. 12. In the present preferred embodiments comprising annular cell configurations, the previously embodied monolithic decoupled electrode assembly accordingly is formed with preferably identical, or nearly identical, apportionment of corresponding MDPEA active region (133), relative to the annular MEA; and, accordingly, such MDPEA active region preferably segmented to provide an annular array of segmented MDPEA active regions, wherein the embodied grid structure of the MDPEA active region is disposed in an annular array with annular width, d_{act}, substantially corresponding in annular dimensions to that of the active region of the previously embodied annular MEA.

Accordingly, similar to the previously embodied MEA, the MDPEA of the present embodiment incorporates a plurality of inner manifold through-hole features (174) that are formed in the inner sealing region (13) of MDPEA support structure (17), so that these inner through-hole features preferably provide air-side manifold passages (93a) for air/steam/oxidizer supply, as well as fuel-side manifold passages (92a) for fuel supply, preferably in the embodied alternating sequence.

Similar to the previously embodied MEA, the MDPEA of the present embodiment incorporates a plurality of outer manifold through-hole features (175) are formed in outer sealing region (12) of MDPEA support structure (17), so that these outer through-hole structures provide air-side manifold passages (93b) for air/steam/oxidizer return, and fuel-side manifold passages (92b) for fuel return, preferably in the embodied alternating sequence. It is preferable that barrier coatings are provided on the preferred stainless steel support structure in accordance with the preferred embodiments.

For providing interconnection between adjacent cells that incorporate the previously embodied annular MEA and, preferably, annular MDPEA, as well as provide gas manifold requirements of such cells, an annular bipolar interconnect plate (BIP) is provided in accordance with a preferred embodiment, wherein the BIP is formed to similarly possess the three regions comprising inner sealing region (13), outer sealing region (12), and an intermediate annular region of width d_{act} for interfacing to the respective active regions of the MEA and MDPEA.

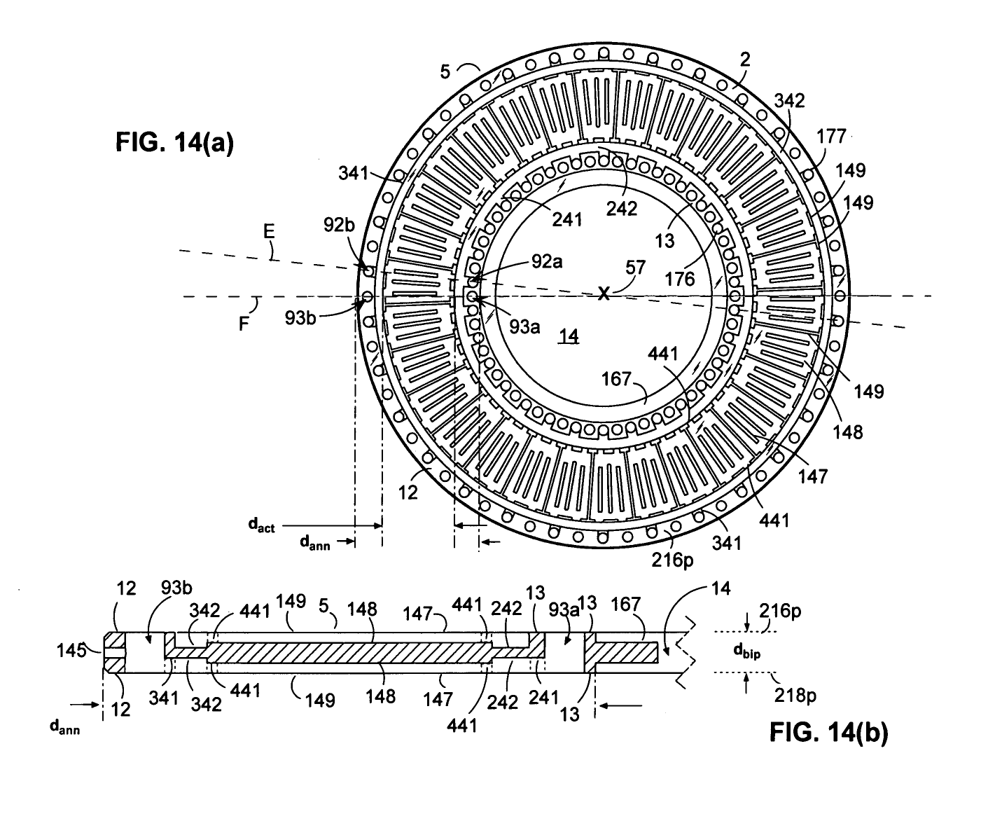

In the present preferred embodiments, the BIP (5) has a first side (216), in FIG. 14(a), which comprises the fuel-side of the BIP, having contacting surface plane (216p) of the first side; and, a second side (218), which comprises the air-side of the BIP, with contacting surface plane (218p) of the second side. In the present preferred embodiments, the first side of the BIP accordingly comprises manifolding means for the fuel-side of the inventive solid oxide cell, and the second side of the BIP accordingly comprises manifolding means for the air-side of the inventive solid oxide cell. The BIP (5) is preferably fabricated from the same metal alloy as the MEA support structure.

Similar to previous embodiments of an annular stack, fuel-side manifold passages (92) and air-side manifold passages (93) are disposed for providing gas manifolding means for displacing operating gases across the inner diameter and outer diameter of the embodied annular active region, thereby providing flow of such gases for electrolytic processes across the active region on respective sides of the embodied electrolytic cell, such passages preferably disposed within the annular sealing regions (12) (13) of the BIP. Such manifolding means are accordingly formed so as to be disposed immediately adjacent and provide surface contact to similar inner and outer annular sealing regions of the previously embodied MEA or MDPEA as is appropriate. In this manner, evenly distributed gas flow means are provided for a radially directed flow of appropriate operating gases across both fuel-side and air-side of the inventive solid oxide electrolytic cell.

On the first side (216) of the BIP, in FIG. 14(a) and in sectional side-view taken through axis F, in FIG. 14(b), fuel-supply manifold passages (92a) and fuel return manifold passages (92b), intersected by projected sectional line E in FIG. 14(a), are communicatively connected to adjacent inner and outer annular gas channels (242) (342) respectively by means of slot features (241) (341) on the fuel-side of the BIP, wherein such annular channels may alternatively be segmented rather than continuous.

On the second side (218) of the BIP, as viewed in side-sectional view in FIG. 14(b) taken through sectional line F, air-supply manifold passages (93a) and air return manifold passages (93b) intersected by projected sectional line F in FIG. 14(a), are communicatively connected to adjacent inner and outer annular gas channels (242) (342) respectively by means of slot features (241) (341) on the air-side of the BIP, wherein such annular channels may alternatively be segmented rather than continuous.

The BIP preferably has projected geometric dimensions, in a top plan view in FIG. 14(a), substantially equivalent to corresponding features in the previously disclosed annular MEA and annular MDPEA, so as to align thereto. Accordingly, the inner manifold through-hole features (176) in inner sealing surface of the annular BIP, form a circular pattern about the inner annular sealing region of the annular BIP, preferably wherein each adjacent manifold through-hole of the embodied circular pattern is alternately in gaseous communication with either of the first side (216) or the second side (218) of the BIP by means of interconnecting slots (241), for supplying respectively either anode-side or cathode-side operating gases thereto; and, the outer manifold through-hole features (177) in outer sealing region of the annular BIP, form a circular pattern about the outer annular sealing region of the annular BIP, preferably wherein each adjacent manifold through-hole of the embodied circular pattern is alternately in gaseous communication with either of the first side (216) or the second side (218) of the BIP by means of interconnecting slots (341), for returning, respectively, either anode-side or cathode-side operating gases therefrom.

Equivalently, in FIG. 14, every other manifold through-hole feature of the circular pattern is disposed to provide gaseous communication with the anode side of an attached cell, whereas the remaining pattern of through-holes provide gaseous communication with the opposite side of the BIP in contact with the cathode side of an adjacent cell of the resulting stack. Accordingly, the first side and second side of the BIP are preferably identical in their respective features, except that the corresponding features intersected by projected sectional lines E and F are reversed, in accordance with the alternating of the embodied inner interconnecting slots (241) and outer interconnecting slots (341), wherein connection of the manifold through-hole features to adjacent annular channels (242) (342) are alternately made to either the fuel-side annular channels, or the air-side annular channels, in FIG. 14. Providing gaseous communication between the inner and outer annular channels of the BIP and the BIP active region are active region manifold slots (441), which accordingly provide slots in the raised ridges (149) for gas flow to and from the BIP active region.

The thickness of the BIP, d_{bip}, is, in centimeters, provided such that, preferably,
0.025 cm≦d_{bip}≦1 cm, and more preferably, 0.1 cm≦d_{bip}≦0.5 cm

although values outside this range may be envisioned.

A BIP active region comprises the annular region of the BIP, having roughly annular width d_{act}, substantially corresponding in annular width and diameter to the annular active regions (11) (133) in the previously embodied MEA and MDPEA, respectively, and accordingly disposed for interfacing to the annular active regions of the MEA and matching MDPEA, with the various embodied BIP channels and slots disposed for containing and controlling flow of operating gases provided for cell operation. In the embodied annular components comprising MEA, MDPEA, and BIP, there are, specifically, thirty such annularly disposed segments in the annularly disposed active region of these respective components, viewable from either side of these components of the preferred embodiments.

In accordance with the embodied BIP, raised ridges (149) define thirty segments corresponding in planar dimensions to annularly disposed MEA active region segments and matching annularly disposed MDPEA active region segments, such corresponding segments of the BIP referred to herein as BIP active region segments. BIP active region segments are accordingly preferably formed in the annularly disposed BIP active region, such raised ridges providing raised sealing surfaces that are surfaced along with the sealing surfaces (12)(13) of the BIP, so that these various sealing surfaces are coplanar with the corresponding contact plane (216p) (218p), and so that these various coplanar sealing regions and raised ridges comprise surfaces disposed for contacting an adjacent annular MEA or MDPEA in accordance with the preferred embodiments. Preferably such coplanar surfaces are provided by surface grinding of the machined, or alternatively stamped, parts, followed by stages of mechanical lapping and/or polishing, preferably so that a surface smoothness of RMS less than 100 micro-inches is provided. Accordingly, in the presently embodied BIP, channel bottom surfaces (148) of channels in the BIP active region are preferably thereby formed by the same preferred machining, or alternatively stamping, process.

Such raised ridges (149) of the BIP active region are preferably disposed so as to roughly delineate and substantially seal around the preferably segmented active regions (11) (133) described in conjunction with the MEA and MDPEA of the preferred embodiments, so that radial portions of the raised ridges (149) provide mating contact surfaces to the non-patterned cross-member lines (161) described in conjunction with the embodied MEA and MDPEA.

In the preferred embodiments, coplanar to these sealing surfaces are electrode contact ridges (147) which both provide further electrical contact to the corresponding MEA or MDPEA, as well as define BIP active region gas channels for providing flow of operating gases therein.

An inter-locking flange (167) is formed along the inner surface of the central hole (14), the inter-locking flange comprising substantially a ledge for referencing to subsequently positioned retainer rings, as well as providing increased surface area, in the manner of cooling fins, within the inventive annular solid oxide electrolytic stack.

It is additionally preferred that sensor means (145), preferably comprising at least a feed-through hole, are disposed in the outer edge of the BIP, such sensor means disposed for attaching temperature sensing means, or alternatively gas sensor means, such sensor means including but not limited to one of any thermocouple, RTD, or any appropriate, preferably thin-film derived, gas sensor.

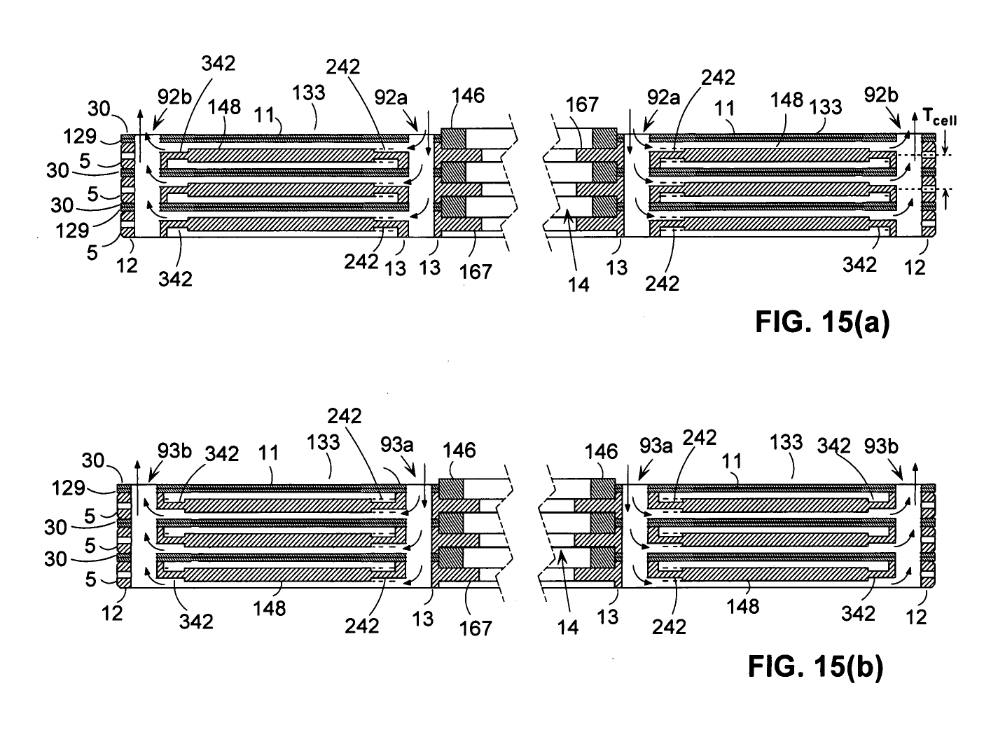

The previously embodied MEA, MDPEA, and BIP are formed with the described dimensions, symmetry, and features, so that these components are sandwiched, or joined, in a repeating fashion, so as to form a resulting embodied SOFC stack; or, alternatively or in alternate operational mode of the same system, an OGS system. Such joining is performed by aligning the respective central axes (57) of these various components so that they may be accordingly mated at their respective contact surfaces. Assembly of the stack is preferably performed by first assembling stackable sub-assemblies; for example, such as a stackable sub-assembly, in FIG. 15(a-b), which comprises three repeating periods of an SOFC stack, though any number of repeating periods may be provided in a desired sub-assembly.

The repeating structure of the embodied annular stack is demonstrated, in FIG. 15, by a repeatable sub-assembly comprising three BIP's interleaved with the mating MEA (30) and MDPEA (129), which comprises in the present embodiment, an MEA/MDPEA couple, so that the embodied triplet sub-assembly is provided from top down in the order of MEA (30)/MDPEA (129)/BIP (5), though several MDPEA's may be provided on one or both sides of the MEA in various alternative embodiments utilizing porous electrode, catalytic, or reformer materials in such MDPEA's.

In particular, pointed out in the present embodiments is a sectional side-view, in FIG. 15(a), of the triplet sub-assembly, wherein the viewable section is taken along a projected sectional line E in FIG. 14(a), which corresponds to sections taken through centers of diametrically disposed fuel manifold passages (92), wherein inner fuel-supply manifold passages (92a) and outer fuel-return manifold passages (92b) are formed by the vertical (in figure) alignment of the respective manifold through-hole features, pointed out in previous embodiments herein with respect to each of the individual components of the embodied repeatable sub-assembly. Accordingly, continuous manifold passages (92) are formed for supplying fuel-bearing gases/vapors to the fuel-side, or anode side, of the BIP, so that such gas is provided for interaction with the anode side of the embodied MEA/MDPEA couple.

Also, in particular, pointed out in the present embodiments is a side-section of the same triplet sub-assembly, in FIG. 15(b), wherein the viewable section is taken along a projected sectional line F in FIG. 14(a), which corresponds to sections taken through centers of a pair of diametrically disposed air manifold passages (93), wherein aligned manifold passages are formed by the respective manifold through-hole features, as pointed out in previous embodiments herein with respect to each of the individual components of the embodied repeatable sub-assembly. Accordingly, continuous manifold passages (93) are formed for supplying oxidizer-bearing gases/vapors to the air-side, or cathode side, of the BIP, so that such gas is provided for interaction with the cathode side of the embodied MEA/MDPEA couple. In these various embodiments, it will be appreciated that, in certain cases, such as in certain alternative OGS or SOFC embodiments, the MEA utilized alone with its embodied electrode layers may be sufficient for the desired electrolytic performance, and so that no MDPEA is utilized in such alternative embodiments. In other alternative embodiments more than one MDPEA may be advantageously utilized on one or both sides of the MEA.

Annularly disposed active regions (11) of the embodied MEA, annularly disposed active regions (133) of the embodied MDPEA (129), and the manifolding features of the BIP corresponding to the active manifolding region, each with annular width, d_{act}, are concentric and aligned so as to provide the portion of the stack wherein electrolytic work is substantially performed.

In addition to the previously disclosed components, an annular retainer ring (146) is incorporated in the repeatable sub-assembly, such retainer ring utilized for providing alignment, and optionally sealing, of the MDPEA, MEA, and BIP components, so that the respective central axes of circular symmetry (57) for each of these components is preferably aligned so as to be coincident in the preferred annular embodiments.

While various sealing mediums and applications may be utilized between the joined surfaces of the embodied stack for providing a hermetic seal, it is preferred that the stack assemblies embodied herein are demountable assemblies, so that one or more of the various embodied annular elements may be separated after usage for replacement, substitution, or for servicing of one or more of the previously assembled stack elements after previously operating the stack. In particular, it is preferred that the surfaces of the embodied annular elements, MEA, MDPEA, and BIP, be formed with adequately planarized and polished surfaces for providing a substantially operational seal. Accordingly, in addition to the preferred micro-roughness comprising preferably less than 100 micro-inches RMS, and more preferably less than 20 micro-inches RMS, it is also preferred that the BIP be fabricated with surface figure across its diameter, as determined by optical interferometry, of better than (or equivalently, less than) a full wave deviation from perfect flatness, and preferably better than a quarter-wave flatness, at wavelength of roughly 528 nm (a standard HeNe wavelength for interferometers). Equivalently, the BIP surfaces are preferably formed with surfaces having, on average, less than roughly half a micron in sag. Such surface figures are readily attained utilizing continuous grinding and continuous polishing methods, equipment, and media commonly utilized in conjunction with fabricating, for example, silicon wafers, silica reference flats, and metallic optics.

Furthermore, in joining the various annular elements of the sub-assembly, as well as other elements of the embodied annular stack, it is not intended that sealing between the various joined sealing regions of the annular elements be limited to any particular sealing method or medium. Accordingly, any acceptable sealing approach for effectively providing a hermetic or quasi-hermetic seal between the mating surfaces of the embodied annular stack may be utilized, including but not limited to glass fits, diffusion bonds, brazes, solders, and various inorganic adhesive materials.

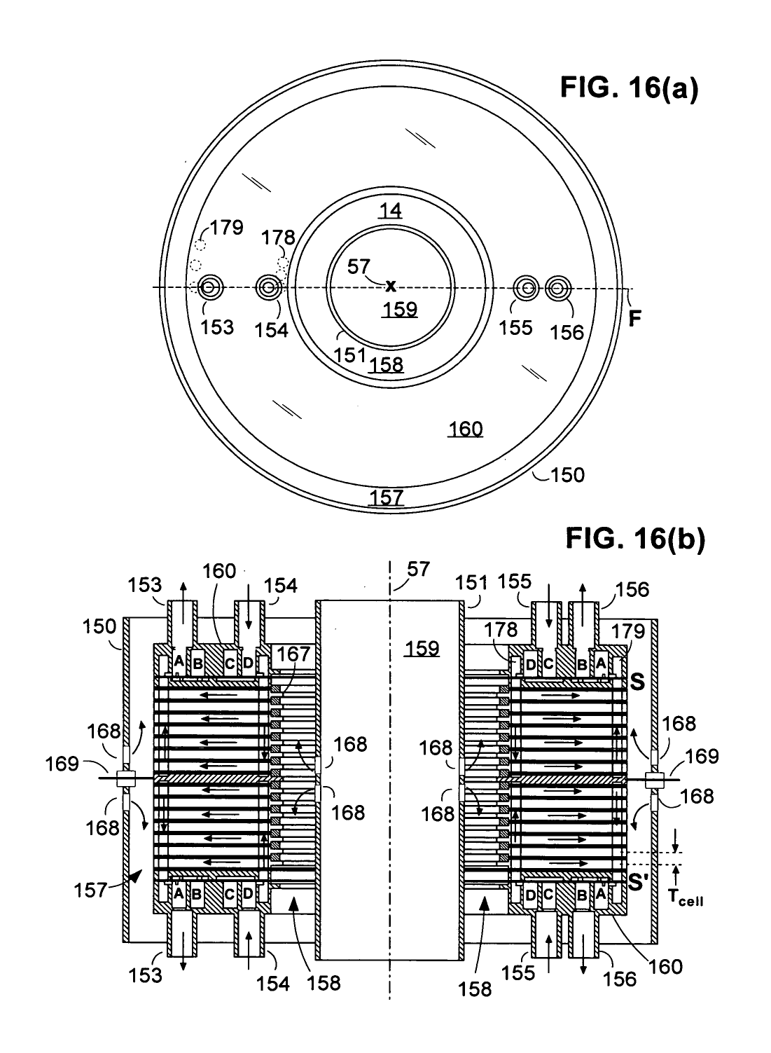

In the preferred embodiments, an annular solid oxide electrolytic stack is provided, in FIG. 16, wherein an integral stack assembly preferably comprises a mirrored stack comprising an effective assembly of two mirrored-stack sub-subassemblies that each are provided with their own, preferably separate, fuel-side and air-side gas circuits. In the preferred embodiments, these mirrored-stack sub-assemblies effectively comprise two, upper and lower, halves of the stack, S and S′, in FIG. 16(b), which effectively mirror one another in their respective features and functions. In the pointed out preferred embodiment, the particularly pointed out stack comprises two mirrored-stack sub-assemblies, each comprising eight cells, for a total stack of eighteen cells; though, of course, the number of cells may vary greatly. Accordingly, annular end-cap assemblies (160) disposed at either end of the embodied SOFC stack preferably include vapor/gas manifolding and delivery means for supply and return of operating gases of both cathode and anode sides of the respective mirrored-stack sub-assembly, S or S′, namely, the respective air-side operating gases and fuel-bearing gases.

Accordingly, the two mirrored-stack sub-assemblies of the preferred embodiments are preferably mirrored in their electrical function as well, so that the interconnection element of the two mirrored sub-assemblies comprises a unipolar interconnect plate (UIP) that, in the preferred embodiments, is a fuel-side anode interconnect to both mirrored-stack sub-assemblies of the inventive solid oxide fuel cell stack. A mid-stack electrical feed-through (169) provides electrical communication between the UIP and external electrical connections (e.g., a power load) of the embodied SOFC. Like wise, it is preferred that oppositely poled electrical connection, the cathode connections at either end of the mirrored stack, be provided by the embodied end-cap assemblies (160). Accordingly, the air-side, or cathode, ends of the mirrored stack sub-assemblies comprise opposite ends of the assembled stack, wherein an end cap assembly (160) at each of the opposite ends of the overall stack also provide gas connections and cathode connections to the external electrical circuit and power load.

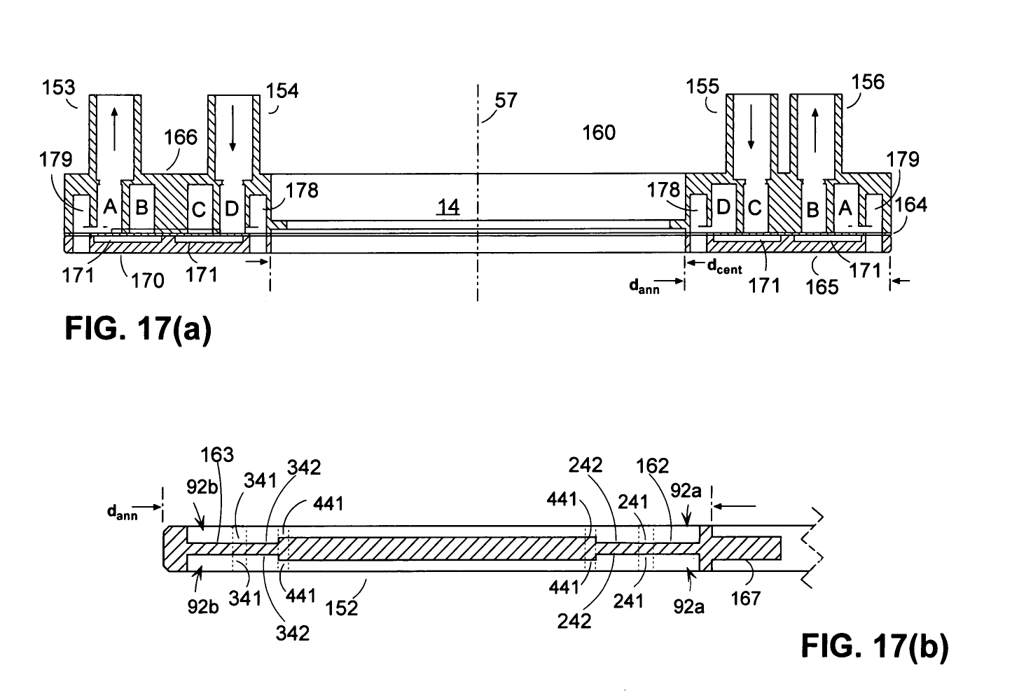

Accordingly, either side of the annular UIP (152), in FIG. 16(b) and FIG. 17(b), is formed with the fuel-side features of the BIP's first side (216), so that such features of the UIP are mirrored on either side of the UIP, rather than staggered as in the embodied BIP. In this way the UIP (152) provides an anode-side gas manifold for the anode-side of each of the two interconnected mirrored-stack sub-assemblies, S and S′.

It is preferred that the embodied stack be useful for combined heat and power applications (CHP) and accordingly, heat exchange means are preferably incorporated in conjunction with the embodied SOFC stack in accordance with the known art. Particularly, it is preferred that such heat exchange means are implemented with use of an outer stack containment tube (150), or alternatively shaped cavity structure, used for effective containment of heat generated by the stack, which tube may include various outer insulating sheaths, as well as interior IR-reflective coatings on appropriately electropolished inner surfaces. Preferably, the interior (14) of the preferred annular stack assembly also comprises heat exchange means that either heat or cool the stack as appropriate. The central interior space (14), formed by the corresponding features of the interconnected elements, including MEA's, MDPEA's, and BIP's, of the stack, further comprises a central space for containing a center tube (151) providing center tube volume (159), which may provide various functions in alternative embodiments of the stack, but is preferably utilized for pre-heating of the operational gases, as well as any additional heat exchange means. Various separate gas circuits of the system may accordingly be passed through or otherwise disposed in the inner tube. One such gas circuit may comprise a separate heat exchange gas means that provides heat exchange gas (e.g., air) into the remaining central interior space of the annular stack, such remaining central interior space comprising the space formed between the outer wall of the center tube (or tubes) and the interior surfaces of the assembled annular stack, thereby forming an inner gas chase (158) wherein preferably the heat exchange gas is provided to remove heat from the stack including previously embodied inter-locking flange surfaces (167), which perform additionally as heat-exchange surfaces, or fins, in the present embodiment. Similarly, an outer gas chase (157) is formed comprising the space between the outer diameter of the stack assembly and the inner surface of the outer tube (150).

Since one of the objectives of the present invention is to provide a symmetric stack that is readily maintained and controlled to operate with a specific and preferably uniform temperature profile, it is also preferred that the heat exchange gas be introduced symmetrically with respect to the overall stack, and accordingly, heat-exchange gas means (168) are preferably disposed mid-way along the stack length, accordingly in the vicinity of the UIP of the present preferred embodiment, so that a heat exchange gas flow is also provided in a mirrored geometry, and so that heat-exchange gas flows uniformly toward, or alternatively, away from, the mid-section of the stack, in FIG. 16. Accordingly, the heat-exchange gas means (168) preferably comprise heat-exchange gas supply passages in both the inner tube and outer tube for providing the heat-exchange gas to the mid-section area of the stack, wherein the inner chase (158) and outer chase (157) provide a flow channel for such gas to flow toward either end of the stack, where it may be collected for providing useful heat to applications, in accordance with known CHP methods.

In accordance with preferred functions of the embodied end-cap assembly (160), gas supply and return interfaces to each of the mirrored sub-stack assemblies, S and S′, are provided by appropriate gas interconnects incorporated into each of the two respective end-cap assemblies. Accordingly, tubes, or otherwise disposed channel means, comprise: oxidizer/air/steam (“air”) return connection (153) for providing connection between an external air-side supply and air-side supply passages (93a); air supply connection (154) for providing connection between an external air-side return and air-side return passages (93b); fuel-bearing gas (“fuel”) supply connection (155) for providing connection between an external fuel-side supply and fuel-side supply passages (92a); and, fuel return connection (156) for providing connection between an external fuel -side return and fuel -side return passages (92b).

In particular, the embodied end-cap assembly (160) preferably comprises an annular end-cap manifold plate (166) that incorporates gas manifold and interconnect means for supplying the operating gases to designated manifold passages of the previously embodied stack elements, in FIG. 17(a).

Accordingly, the air supply connection (154) is communicatively attached to annular manifold space D, which is accordingly disposed for providing oxidizing gas to the air-sides or cathode-sides of the embodied cells. The air return connection (153) is communicatively attached to annular manifold space A, which is accordingly disposed for removing oxidizing gas from the cathode-sides of the embodied cells.

Also, the fuel supply connection (155) is communicatively attached to annular manifold space C, which is accordingly disposed for providing fuel-bearing gas to the fuels-sides, or anode-sides, of the embodied cells. The fuel return connection (156) is communicatively attached to annular manifold space B, which is accordingly disposed for out-flow of depleted fuel-bearing gas from the anode-sides of the embodied cells.

Outer manifold hole features (179) are formed in outer annular sealing region of the end-cap manifold. Likewise, inner manifold hole features (178) are formed in inner annular sealing region of the end-cap manifold, such annular regions and hole-feature placement aligning to similar sealing regions of the stack. In the viewable side-section, in FIG. 17(a), taken along a projected section line F, air-side connections are accordingly in open communication with their respective air-side manifold passages, which, similar to previous embodiments, comprise alternate instances of manifold hole features (178) (179) in the respective inner and outer annular sealing region of the end-cap manifold.

So as to align with similar features of previously embodied MEA, MDPEA, and BIP, both inner and outer pluralities of manifold hole features (178) (179) are disposed in respective inner and outer annular sealing regions of the end-cap manifold and are, accordingly, communicatively attached in, alternation, to one of either the air-side passages (93) or the fuel-side passages (92) of the embodied stack. Accordingly, fuel-side annular manifold spaces C and D are in gaseous communication with fuel-side manifold hole features by way of appropriately placed openings in annular end-cap separator plate (164), by which the fuel-bearing gas is provided to annular manifolds (171) in annular end-cap interconnect plate (165), and so that a section through a projected sectional line E in accordance with the preferred embodiments would likewise expose open connection between an adjacent annular manifold (171) and the respective inner or outer fuel passages. In this way, the respective supply and return annular manifold spaces formed in the end-cap manifold plate (166) are disposed so as to be in fluid communication with their respective air-side and fuel-side gas circuits. These various components of the end-cap assembly are preferably machined from the same metal alloy as the previous stack elements, and preferably coated with similar electrically conductive barrier coatings.

The end-cap interconnect plate (165) interconnects to the first adjacent electrolytic cell of the stack sub-assembly, and preferably provides gas flow means for the air-side, or cathode side, so that the interfacing surface (170) of the end-cap interconnect plate is preferably formed with features identical to the air-side, or second side (218) of the BIP.

In accordance with its preferred function as the anode for abutting mirrored stack sub-assemblies, the Unipolar Interconnect Plate (152), in FIG. 17(b), is preferably formed with features in accordance with one side of the BIP, preferably the fuel side (216) of the BIP. In its function as a separation plate that substantially separates the respective gas flow circuits of the respective mirrored-stack sub-assemblies, S and S′, the UIP preferably has accordingly blocked manifold holes (162) (163), in FIG. 17(b), respectively in inner and outer sealing regions of the UIP, which blocked holes align with the corresponding manifold through-hole features forming manifold passages of the embodied stack sub-assemblies.

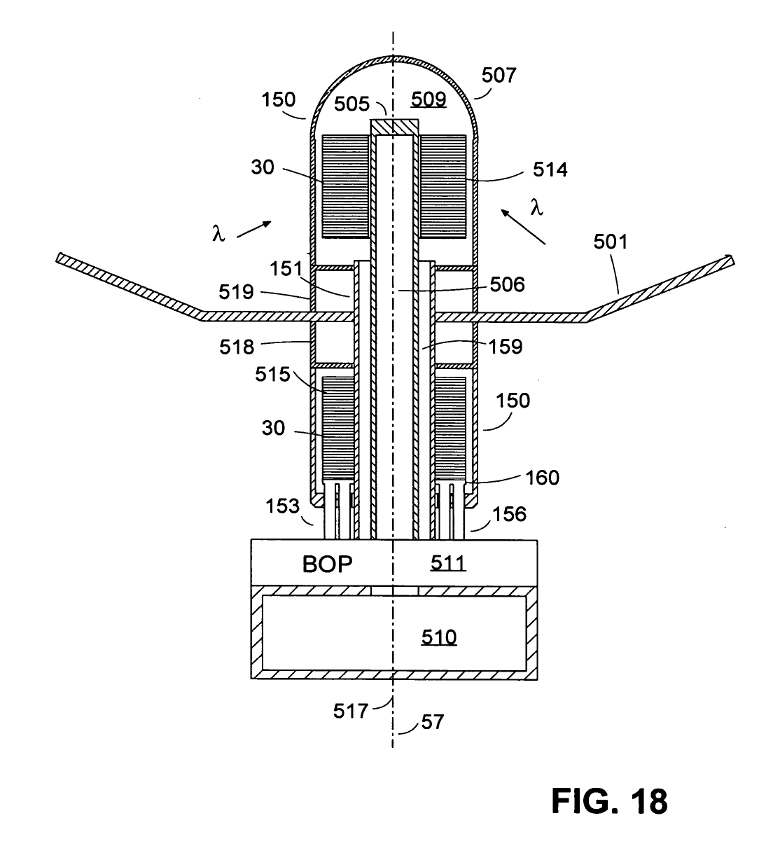

In a further alternative embodiment, in FIG. 18, the solid oxide electrolytic devices of the previous embodiments are utilized in an inventive solar-powered conversion device that is preferably utilized for generating electrical power, or alternatively for gas separation, or for both simultaneously. Accordingly an annular solid oxide gas separation device in accordance with the previous embodiments is irradiated with solar radiation X from a concentrically positioned solar concentrator, wherein the gas separation device is accordingly heated to high temperatures suitable for efficient generation of a hydrogen-rich gas, which gas is stored in an integral storage tank (510) for usage by a coaxially mounted, annular solid oxide fuel cell constructed in accordance with the previous preferred embodiments. A critical realization of the present invention in the present embodiment is that, for photocatalysis utilizing solid oxide electrolyzers to proceed efficiently, it is very enabling to the photocatalytic reaction process at the catalytic electrode surface for the supporting electrolyte to be as thin as possible. If the oxide electrolyte layer can be implemented with sub-micrometer—and preferably less than 500 nanometers—thickness, then the sampling rate of oxygen vacancies to a specific area of an adjacent, porous, catalytic electrode, can be much higher than that allowed by thicker electrolyte layers. This is essential if the sampling rate of the oxygen vacancies at the electrolyte/catalytic electrode interface is to not be a limiting rate in the ability of the catalyst to execute the preferred reaction steps that lead to an oxygen ion being transported through the electrolyte.

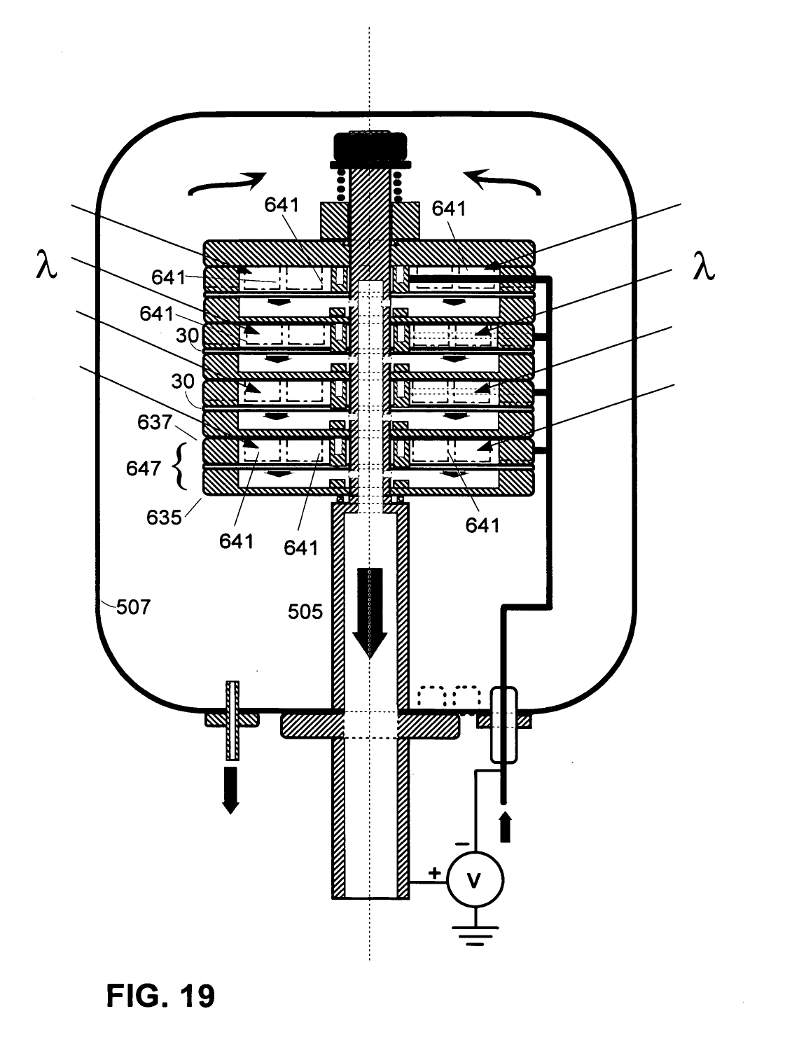

In the present embodiments, the cathode, or oxygen-adsorbing electrode (cathode) of the embodied solid oxide gas separation device (or OGS) utilizing the embodied MEA, is preferably irradiated directly by solar radiation reflected from the solar concentrator. Irradiation of the embodied OGS (oxygen, or equivalently, hydrogen generation system) is preferably achieved in a stack wherein the outer passages (92b) (93b) are preferably eliminated and sealing regions of the MEA are preferably eliminated on the hydrogen-rich side of the embodied MEA, so that only the oxygen-rich side of the MEA is sealed from fluid communication with the glass enclosure space (509). Accordingly, the oxygen-rich side of the MEA's are accessed through a central support tube (505). Movement of oxygen-rich gas from the oxygen rich-side of the MEA is provided at least in part by the oxygen conduction of the embodied solid oxide electrolytic layer, and is provided through the inner sealing region to the oxygen return passage (506). Accordingly propagation of solar radiation preferably enters the disk-shaped flow spaces interleaving MEA's of the OGS stack, these disposed for a supplied water vapor/carbon-bearing gas interleaving the embodied MEA's of the embodied annular stack. In FIG. 19, showing a sectional side-view of an gas separation stack being irradiated with solar propagation, such annular solid oxide stacks in fluid communication with an outer enclosure space are taught in the prior art, such as the OGS stack taught in U.S. patent application Ser. No. 10/411,938 (particularly in association with FIG. 9 of that application). In such embodiments, peripheral passages to the hydrogen-rich side of the embodied MEA, such as in the bipolar plate(637), in FIG. 19, are accordingly rendered as large as is appropriate for entrance of the desired solar propagation, so that accordingly open spaces (641) interleave individual cells of the electrolyzer stack, and solar radiation from the concentric solar concentrator of the present embodiments is incident upon the porous electrode material of the hydrogen-rich side of the MEA and adjoining bipolar manifolds (635) (637). Alternatively, the annular OGS component (514) of the present embodiments may comprise a tubular MEA as taught in the tubular fuel cell and OGS art. The oxygen-adsorbing electrode of the centrally-disposed oxygen/hydrogen generation stack (514) is accordingly formed as a porous electrode that incorporates photo-catalytic compositions, preferably a platinum-TiO₂ composition that efficiently dissociates water into hydrogen gas and oxygen ions, such that the oxygen ions subsequently conduct through the solid oxide membrane, or alternatively compositions including LSM or any appropriate photocatalytic electrode composition found suitable in the art of solid-oxide-based photocatalysis.

Accordingly, a concentric solar concentrator (501) preferably comprising a parabolic, compound parabolic, or more preferably several conic frustums, and having a central axis of the solar concentrator (517), is utilized to irradiate a centrally disposed, annular, solid oxide electrolyzing stack of the preferred embodiments, so that the annular electrolyzing (gas generating) stack is accordingly irradiated and heated by the solar concentrator for separating and producing hydrogen-rich and oxygen-rich gases and/or vapors at opposing porous electrodes of the MEA. There is accordingly utilized a central support tube (505) preferably disposed for containing return flow of oxygen from oxygen emitting side of the solid oxide gas separation device (514) with oxygen return passage (506) for oxygen-rich gas produced from the solid oxide gas separation device (514). A transparent enclosure (507) encloses the annular gas-separation stack for containing the hydrogen-rich gases, preferably comprising a supply passage therefore, the enclosure preferably comprising a hemi-spherically-terminated glass tube composed of preferably a borosilicate or more preferably a fused silica glass tube terminated on top with a hemispherical end. Accordingly, the solid oxide gas separation device is disposed concentrically in the glass enclosure space (509) formed by the transparent enclosure further disposed for containing water-vapor or other oxygen-bearing vapor/gas for delivery to the oxygen-adsorbing electrodes of the solid oxide gas separation device, whereby hydrogen gas is dissociated at the electrode surfaces by photocatalysis, rendering the gas circuit of the glass enclosure space hydrogen rich. The transparent enclosure for transmitting solar radiation therein is preferably supported by a concentric stack mounting structure insulating the glass enclosure thermally from the concentric concentrator structure (501). Similar fuel cell mounting means (518) are provided for insulating the fuel cell (515) from the concentrator as well.

A hydrogen storage tank (510) is preferably mounted integrally to the presently embodied assembly, preferably integral to a balance-of-plant (BOP) assembly (511) integrally mounted to the embodied assembly for providing fuel (preferably hydrogen) to the solid oxide fuel cell mounted below the solar concentrator. The BOP assembly is constructed in accordance with the gas flow, composition, temperature, and cut-off mechanism commonly incorporated in the known art of solid oxide fuel cells, such BOP means preferably controlling hydrogen fuel pressures and flows to and from the hydrogen storage tank, and preferably supplying appropriate hydrogen rich gases and exhaust control for the preferred annular solid oxide fuel cell (515). The solid oxide fuel cell (515), preferably is an annular solid oxide fuel cell in accordance with the preferred embodiments of FIGS. 2-17, and is disposed concentric to the central axis of the solar concentrator (517). Hydrogen that is stored in the hydrogen storage tank is then available for powering the fuel cell stack, and producing electrical power during periods in which the solar concentrator is or is not illuminated.

It is not intended that the embodied solar-powered conversion device be limited to integral assemblies that incorporate all components of the present preferred solar embodiments. For example, in some cases, the disclosed annular fuel cell stack may be incorporated concentrically to a solar concentrator for pre-heating, or alternatively providing supplemental heating to, a heat transfer fluid (HTF), such as a high-temperature molten salt, that is being heated by the solar concentrator. In a further alternative embodiment, the hydrogen/oxygen separation stack may be utilized alone for storing hydrogen for remote usage, such as for hydrogen-powered automobiles. Accordingly, additional storage means may be utilized for storing energy in the form of heat, electricity, pressure, mechanical energy, or any other form of energy that may be stored by an energy storage means. It is also not required that the gas-separation stack be necessarily photocatalytic, or that it be disposed in the embodied solar-powered conversion device for direct irradiation, as the solid oxide gas-separation stack may be disposed below the concentrator so as to be operatively heated by a HTF that is heated by the solar concentrator.

Like parts correspond to like parts in different embodiments; for example, the centerline (57) representing the axis of circular symmetry is to be regarded as such axis with respect to the specific embodiment in which it is pointed out. Reference throughout this specification to “one embodiment” or “an embodiment” means that a particular feature, structure, process, block, or characteristic described in connection with the embodiment is included in at least one embodiment of the present invention. Thus, the appearances of the phrases “in the present embodiment” or “in another embodiment” in various places throughout this specification are not necessarily all referring to the same embodiment. Furthermore, the particular features, structures, or characteristics may be combined in any suitable manner in one or more embodiments.

### INDUSTRIAL APPLICABILITY

The embodied solid-oxide monolithic assemblies comprising positive-electrode/electrolyte/negative-electrode (PEN) assemblies, as well as the accompanying embodied fuel cell designs, may be accordingly be utilized in any of the appropriate applications where such assemblies are known to find application. Such devices are of interest as viable options for power-generating fuel cells, as well as for producing pure oxygen, hydrogen, and other such gases that may be produced through dissociation of oxygen-bearing gases. Potential applications of the preferred embodiments are portable, stationary, automotive, uninterruptible power supplies (UPS), auxiliary power units (APU), combined heat and power (CHP) systems for on-site power, coal gasification and syngas utilization; power output from resulting devices may be sub-kilowatt to multi-kilowatt.

It should be understood by those skilled in the art of power conversion devices and their related thermodynamic systems that the disclosed SOFC and solar heat-source is not limited to its various preferred embodiments, as any application benefiting from a supplemental or primary heat source may be readily utilized in various arrangements with the presently disclosed heat source. Accordingly, any known application, process or apparatus that can benefit from the embodied SOFC, electrolyzers, or solar-powered heat transfer medium (such as a gas, a liquid, or IR radiating surface) may readily be combined with the presently disclosed embodiments without departing from the scope or spirit of the disclosed embodiments.

In particular, it should be readily understood by those skilled in the art that processes and apparatus for any electrical power generation whether localized, power-plant, on-site CHP, distributed-generation, portable, roof-top, auxiliary power units (APU) including marine-based or other transportation-based APU's, or any other such electrical power generation apparatus or process may be readily combined by those skilled in the art with the disclosed embodiments without departing from the intended scope and applications.

Similarly, the disclose embodiments may be combined with known power conversion processes and apparatus for such applications as materials processing and refinement, gas and liquid processing and refinement, fuel conversion processes, methane conversion, hydrocarbon conversion, gasification including coal gasification processes, electrolytic processes, swing-cycle air conditioning and refrigeration, heating and cooling, gas-shift reactions, steam conversion, and other well-known power conversion means that can be readily combined with the disclosed sofc-solar-thermal source in accordance with principles well-understood by those skilled in the art of these respective thermodynamic processes, and accordingly are not outside the scope of the disclosed invention.

Such known power-conversion apparatus may also include electrolytic power conversion processes, any type of fuel cell or flow battery, known power generation and/or energy conversion processes including wind, solar, hydroelectric, nuclear, coal, natural gas, any storage device including batteries, fuel cells, a tank or reservoir for thermal-heat or chemical-energy storage medium, and any other such process, application, or apparatus that could benefit by combination with a supplemental or primary heat generating source, can benefit from combination with the disclosed solar-powered heat generation apparatus without departing form the scope and spirit of the disclosed invention.

In accordance with these well-known and understood applications of the prior art, the disclosed solar apparatus may accordingly be readily combined with known elements common to these energy conversion cycles, processes, and apparatus. including but not limited to wind, solar, hydroelectric, nuclear, coal, natural gas, any storage device including batteries, fuel cells, any appropriate tank or reservoir for a thermal-heat or chemical-energy storage medium, and any other such process, application, or apparatus that could benefit by combination with a supplemental or primary heat generating source, can be combined with the disclosed solar-powered heat generation apparatus without departing form the scope and spirit of the disclosed invention.

Accordingly, it is understood that “flow-chart engineering” of some particular combination of such elements and processes of the prior art, when it is combining such known processes and apparatus so as to interact according to demonstrated and known principles, will be readily anticipated by those skilled in the art, and therefore are well within the scope of the disclosed heat generating apparatus.

In particular, it should be understood that one skilled in the art can readily combine numerous identifiable and known processes and apparatus that operate together under known principles of the prior art, for combination in and combine such processes and apparatus in innumerable combinations that might benefit from a heat-source. Such flow-chart “engineering” is considered here to be readily performed by those skilled in the art. This includes the practice of drawing boxes around two more items in what is essentially a flow-chart description, and suggesting it is therefore “modular” or “integral” or “portable”.

Although the present invention has been described in detail with reference to the embodiments shown in the drawing, it is not intended that the invention be restricted to such embodiments. It will be apparent to one practiced in the art that various departures from the foregoing description and drawings may be made without departure from the scope or spirit of the invention.

What is claimed is:

1. A monolithic assembly in a solid oxide electrolytic device, comprising:
a.) a monolithic support structure having a first side and a second opposing side, the structure residing substantially between a first plane and a second parallel plane, the first plane intersected by contact surfaces of the first side, the second plane intersected by contact surfaces of the second side, the contact surfaces of the second side comprising a periodic array of raised features separated by via features, the raised features and via features interspersed between a periodic array of through-hole features, the via features forming via spaces communicatively connecting adjacent through-hole structures of the support structure;
b.) an electrolyte layer formed within the through-hole features, the electrolytic layer having a first electrolyte side and a second electrolyte side
c.) a first electrode material formed over the first electrolyte side of the electrolyte layer; and
d.) a second electrode material formed over the second side of the electrolyte layer.

2. The monolithic assembly of claim 1, wherein the solid oxide electrolytic device is a solid oxide fuel cell.

3. The monolithic assembly of claim 1, wherein the solid oxide electrolytic device is a solid oxide gas separation device.

4. The monolithic assembly of claim 3, wherein the solid oxide electrolytic device is utilized for hydrogen generation.

5. The monolithic assembly of claim 1, wherein the support structure is a steel sheet of thickness on the order of one-hundred to several hundred micrometers.

6. The monolithic assembly of claim 1, wherein the electrolytic layer has a thickness less than one micrometer.

7. The monolithic assembly of claim 1, wherein the MEA is incorporated in an annular solid oxide electrolytic stack having radial gas flow means.

8. The monolithic assembly of claim 1, wherein the MEA incorporates porous electrode materials.

9. A process for forming a monolithic assembly in a solid oxide electrolytic device, including the steps:
a.) forming a patterned layer of inorganic material onto a rolled metal sheet, the patterned layer comprising a periodic pattern of contact surfaces;
b.) removing material from the metal sheet in the patterned openings by an ionic solution means, thereby forming a periodic array of through-hole features, wherein interstices of the through-hole features form at least three pedestal features around each through-hole feature;
c.) providing a smoothly surfaced sacrificial material within the through-hole features;
d.) forming an electrolyte layer over the sacrificial material;
e.) removing the sacrificial material so as to provide a free-standing electrolyte layer, the free-standing electrolyte layer disposed within each hole structure so as to provide an effective gas barrier to a gas passing into the through-holes, the layer comprising a metal oxide electrolyte; and,
f.) forming electrode layers on opposing sides of the electrolyte layer, wherein the electrode layers are disposed for enabling an electrolytic function.

10. The process of claim 9, wherein the solid oxide electrolytic device is a solid oxide fuel cell.

11. The process of claim 9, wherein the solid oxide electrolytic device is a solid oxide gas separation device.

12. The process of claim 9, wherein the sacrificial material comprises a portion of the metal sheet.
